(19) United States
(12) Patent Application Publication
(10) Pub. No.: US 2026/0202913 A1
(43) Pub. Date: Jul. 16, 2026

(54) EXTENDED REALITY (XR) DEVICE MANAGEMENT USING EYE TRACKING SENSORS

(71) Applicant: QUALCOMM Incorporated, San Diego, CA (US)

(72) Inventors: Manmohan MANOHARAN, Bengaluru (IN); Kapil AHUJA, Bengaluru (IN); Wesley James HOLLAND, Encinitas, CA (US); Simon Peter William BOOTH, San Diego, CA (US); Pawan Kumar BAHETI, San Diego, CA (US)

(21) Appl. No.: 19/471,669

(22) PCT Filed: Oct. 2, 2023
(86) PCT No.: PCT/US2023/075745

§ 371 Date: Oct. 1, 2025

(30) Foreign Application Priority Data
May 12, 2023 (IN) 202341033507

(51) Int. Cl. G06F 3/01; G06F 3/0484

(52) U.S. Cl. CPC G06F 3/013; G06F 3/0484; G06F 2203/04804

(57) ABSTRACT

Systems and techniques are provided for imaging. For example, a process can include determining a direction of gaze of a user toward one or more displays, wherein the direction of gaze is based on image data obtained using one or more cameras. The process can include determining a region of the one or more displays corresponding to the direction of gaze of the user. The process can include generating one or more graphical user interface (GUI) control actions indicative of a respective configuration of a GUI associated with the one or more displays, wherein the one or more GUI control actions are based on the determined region. The process can include outputting, using the one or more displays and based on the one or more GUI control actions, the respective configuration of the GUI.

### FIELD

The present disclosure generally relates to processing image data in an extended reality system. For example, aspects of the present disclosure are related to systems and techniques for providing graphical user interface management for an extended reality device.

### BACKGROUND

Extended reality (XR) technologies can be used to present virtual content to users, and/or can combine real environments from the physical world and virtual environments to provide users with XR experiences. The term XR can encompass virtual reality (VR), augmented reality (AR), mixed reality (MR), and the like. XR systems can allow users to experience XR environments by overlaying virtual content onto images of a real world environment, which can be viewed by a user through an XR device (e.g., a head-mounted display (HMD), extended reality glasses, or other device). For example, an XR device can display an environment to a user. The environment is at least partially different from the real-world environment in which the user is in. The user can generally change their view of the environment interactively, for example by tilting or moving the XR device (e.g., the HMD or other device). In some cases, an XR system can include a “see-through” display that allows the user to see their real-world environment based on light from the real-world environment passing through the display. In some cases, an XR system can include a “pass-through” display that allows the user to see their real-world environment, or a virtual environment based on their real-world environment, based on a view of the environment being captured by one or more cameras and displayed on the display. “See-through” or “pass-through” XR systems can be worn by users while the users are engaged in activities in their real-world environment.

In some cases, the XR system can include an eye imaging (also referred to herein as gaze detection or eye tracking) system. In some examples, eyes of the user of an XR system can move over a large range of offset and/or rotation. In some cases, the eyes of a user of an XR system can have different alignment relative to the display.

### BRIEF SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Systems and techniques are described for processing image data. According to at least one example, a method is provided for processing image data. The method includes: determining a direction of gaze of a user toward one or more displays, wherein the direction of gaze is based on image data obtained using one or more cameras; determining a region of the one or more displays corresponding to the direction of gaze of the user; generating one or more graphical user interface (GUI) control actions indicative of a respective configuration for a GUI associated with the one or more displays, wherein the one or more GUI control actions are based on the determined region; and outputting, using the one or more displays and based on the one or more GUI control actions, the respective configuration of the GUI.

In another illustrative example, an apparatus for imaging is provided that includes a memory (e.g., configured to store data, such as audio data, etc.) and one or more processors (e.g., implemented in circuitry) coupled to the memory. The one or more processors are configured to and can: determine a direction of gaze of a user toward one or more displays, wherein the direction of gaze is based on image data obtained using one or more cameras; determine a region of the one or more displays corresponding to the direction of gaze of the user; generate one or more graphical user interface (GUI) control actions indicative of a respective configuration for a GUI associated with the one or more displays, wherein the one or more GUI control actions are based on the determined region; and output, using the one or more displays and based on the one or more GUI control actions, the respective configuration of the GUI.

In another illustrative example, a non-transitory computer-readable medium is provided that has stored thereon instructions that, when executed by one or more processors, cause the one or more processors to: determine a direction of gaze of a user toward one or more displays, wherein the direction of gaze is based on image data obtained using one or more cameras; determine a region of the one or more displays corresponding to the direction of gaze of the user; generate one or more graphical user interface (GUI) control actions indicative of a respective configuration for a GUI associated with the one or more displays, wherein the one or more GUI control actions are based on the determined region; and output, using the one or more displays and based on the one or more GUI control actions, the respective configuration of the GUI.

In another illustrative example, an apparatus is provided. The apparatus includes: means for determining a direction of gaze of a user toward one or more displays, wherein the direction of gaze is based on image data obtained using one or more cameras; means for determining a region of the one or more displays corresponding to the direction of gaze of the user; means for generating one or more graphical user interface (GUI) control actions indicative of a respective configuration for a GUI associated with the one or more displays, wherein the one or more GUI control actions are based on the determined region; and means for outputting, using the one or more displays and based on the one or more GUI control actions, the respective configuration of the GUI.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative examples of the present application are described in detail below with reference to the following figures:

FIG. 1A is a diagram illustrating an example of an extended reality (XR) system, in accordance with some examples;

FIG. 1B is a perspective diagram illustrating a head-mounted display (HMD), in accordance with some examples;

FIG. 1C is a perspective diagram illustrating the head-mounted display (HMD) of FIG. 1B being worn by a user, in accordance with some examples;

FIG. 2 is a diagram illustrating an architecture of an example XR system, in accordance with some examples;

FIG. 3 is a block diagram illustrating another example XR system, in accordance with some examples;

FIG. 4 is a diagram illustrating an example of an XR system with one or more user interface (UI) trigger zones and one or more UI defocus zones, in accordance with some examples;

FIG. 5 is a diagram illustrating an example of an eye tracking graphical user interface (GUI) management system, in accordance with some examples;

FIG. 6 is a diagram illustrating an example of a GUI rendering process for an XR system when a user gaze is detected towards a UI trigger zone, in accordance with some examples;

FIG. 7 is a diagram illustrating an example of a GUI rendering process for an XR system when a user gaze is detected towards a UI defocus zone, in accordance with some examples;

FIG. 8 is a diagram illustrating an example of the eye tracking GUI management system of FIG. 5 with one or more multimodal sensor data inputs, in accordance with some examples

FIG. 9 is a flow diagram illustrating an example control loop for XR GUI management using eye tracking sensors, in accordance with some examples;

FIG. 10 is a flow diagram illustrating a process for image processing, in accordance with some examples; and

FIG. 11 is a diagram illustrating an example of a computing system for implementing certain aspects described herein.

### DETAILED DESCRIPTION

Certain aspects and examples of this disclosure are provided below. Some of these aspects and examples may be applied independently and some of them may be applied in combination as would be apparent to those of skill in the art. In the following description, for the purposes of explanation, specific details are set forth in order to provide a thorough understanding of subject matter of the application. However, it will be apparent that various examples may be practiced without these specific details. The figures and description are not intended to be restrictive.

The ensuing description provides illustrative examples only, and is not intended to limit the scope, applicability, or configuration of the disclosure. Rather, the ensuing description will provide those skilled in the art with an enabling description for implementing the illustrative examples. It should be understood that various changes may be made in the function and arrangement of elements without departing from the spirit and scope of the application as set forth in the appended claims.

Extended reality (XR) systems or devices can provide virtual content to a user and/or can combine real-world or physical environments and virtual environments (made up of virtual content) to provide users with XR experiences. The real-world environment can include real-world objects (also referred to as physical objects), such as people, vehicles, buildings, tables, chairs, and/or other real-world or physical objects. XR systems or devices can facilitate interaction with different types of XR environments (e.g., a user can use an XR system or device to interact with an XR environment). XR systems can include virtual reality (VR) systems facilitating interactions with VR environments, augmented reality (AR) systems facilitating interactions with AR environments, mixed reality (MR) systems facilitating interactions with MR environments, and/or other XR systems. Examples of XR systems or devices include head-mounted displays (HMDs), smart glasses, among others. In some cases, an XR system can track parts of the user (e.g., a hand and/or fingertips of a user) to allow the user to interact with items of virtual content.

AR is a technology that provides virtual or computer-generated content (referred to as AR content) superimposed over the user's view of a physical, real-world scene or environment. AR content can include virtual content, such as video, images, graphic content, plaintext, location data (e.g., global positioning system (GPS) data or other location data), sounds, any combination thereof, and/or other augmented content. An AR system or device is designed to enhance (or augment), rather than to replace, a person's current perception of reality. For example, a user can see a real stationary or moving physical object through an AR device display, but the user's visual perception of the physical object may be augmented or enhanced by a virtual image of that object (e.g., a real-world car replaced by a virtual image of a DeLorean), by AR content added to the physical object (e.g., virtual wings added to a live animal), by AR content displayed relative to the physical object (e.g., informational virtual content displayed near a sign on a building, a virtual coffee cup virtually anchored to (e.g., placed on top of) a real-world table in one or more images, etc.), and/or by displaying other types of AR content. Various types of AR systems can be used for gaming, entertainment, and/or other applications.

In some cases, an XR system can include an optical “see-through” or “pass-through” display (e.g., see-through or pass-through AR HMD or AR glasses), allowing the XR system to display XR content (e.g., AR content) directly onto a real-world view without displaying video content. For example, a user may view physical objects through a display (e.g., glasses or lenses), and the AR system can display AR content onto the display to provide the user with an enhanced visual perception of one or more real-world objects. In one example, a display of an optical see-through AR system can include a lens or glass in front of each eye (or a single lens or glass over both eyes). The see-through display can allow the user to see a real-world or physical object directly, and can display (e.g., projected or otherwise displayed) an enhanced image of that object or additional AR content to augment the user's visual perception of the real world (e.g., such as the inside of a building or machine). In some cases, an XR system may allow a user to interact with an environment around the XR system.

Various XR systems that are worn by a user and provide an optical see through or pass-through display can be collectively referred to as “smart glasses” or an “XR glasses device.” In some cases, smart glasses can include one or more graphical user interfaces (GUIs) to provide information to the user, to provide user interactions and/or inputs, etc. In some cases, smart glasses can implement voice-based and/or touch-based control of the one or more GUIs of the smart glasses. In some examples, a smart glasses wearer may be in a situation where the voice-based control and/or the touch-based control of the GUI may not be feasible or would distract the smart glasses wearer from a situation which the smart glasses wearer is focused on.

For instance, a smart glasses wearer who is riding a bicycle over an unknown route may utilize map assistance to navigate the route, where the map assistance is presented using a GUI of the smart glasses. For example, the map assistance GUI can be presented as an optical see-through or pass-through display of the smart glasses. The map assistance may be presented while the smart glasses wearer is actively moving (e.g., riding the bicycle). Issues of safety, distraction, etc., may be associated with GUI elements on the smart glasses display that occlude some (or all) of the smart glasses wearer's vision or field of view through the smart glasses. There is a need for XR system (e.g., smart glasses) GUI management that does not occlude the vision of a wearer when focusing on his or her surrounding environment beyond or through the smart glasses display. There is a further need for XR system (e.g., smart glasses) GUI management that can be implemented without using touch-based and/or voice-based control. For instance, the smart glasses wearer may not be in a position to halt and look for directions, or take his or her hands off of the bicycle handlebars to seek navigation guidance. Additionally, background or other ambient noise may prevent voice-activated GUI control for the smart glasses.

Systems, apparatuses, methods (also referred to as processes), and computer-readable media (collectively referred to herein as “systems and techniques”) are described herein for processing image data in an XR system. The systems and techniques described herein may include an XR device, including an image-capture device, that may capture images. The XR device can perform GUI management based on a direction of gaze or focus determined for a wearer of the XR device. In one illustrative example, the XR device comprises smart glasses. The wearer of the XR device (e.g., smart glasses) can also be referred to as the user of the XR device or smart glasses.

In some aspects, the direction of gaze can be determined using one or more cameras that monitor the eyes of the smart glasses wearer. For instance, the one or more cameras can be provided in the smart glasses frame and oriented towards the eyes of the smart glasses wearer (e.g., user). The smart glasses lens area (e.g., XR display area) can be divided into different zones. For instance, the smart glasses lens area or viewing area can include a first portion corresponding to a UI defocus zone and a second portion corresponding to a UI trigger zone. The zones can be pre-determined and/or selected arbitrarily. In some examples, the location and/or size of the UI defocus zone and/or the UI trigger zone can vary based on the location(s) of the eye tracking camera and framework. In some cases, the systems and techniques described herein can be used to detect the zone at which the gaze of the user is directed, using data obtained from the one or more eye tracking cameras provided on the XR device (e.g., smart glasses).

Various aspects of the application will be described with respect to the figures below.

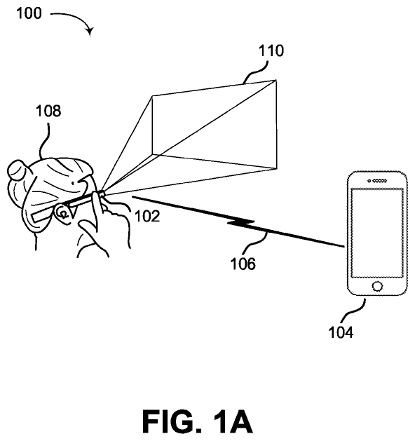

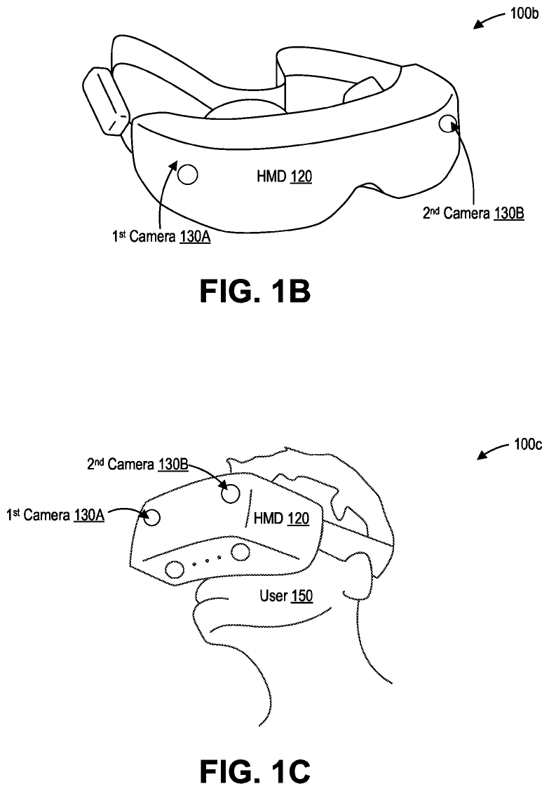

FIG. 1A is a diagram illustrating an example of an extended reality (XR) system 100, in accordance with some examples. As shown, XR system 100 includes an XR device 102, a companion device 104, and a communication link 106 between XR device 102 and companion device 104. In some cases, XR device 102 may generally implement display, image-capture, and/or view-tracking aspects of extended reality, including virtual reality (VR), augmented reality (AR), mixed reality (MR), etc. In some cases, companion device 104 may generally implement computing aspects of extended reality. For example, XR device 102 may capture images of an environment of a user 108 and provide the images to companion device 104 (e.g., via communication link 106). Companion device 104 may render virtual content (e.g., related to the captured images of the environment) and provide the virtual content to XR device 102 (e.g., via communication link 106). XR device 102 may display the virtual content to a user 108 (e.g., within a field of view 110 of user 108).

Generally, XR device 102 may display virtual content to be viewed by a user 108 in field of view 110. In some examples, XR device 102 may include a transparent surface (e.g., optical glass) such that virtual objects may be displayed on (e.g., by being generated at or projected onto) the transparent surface to overlay virtual content on real-word objects viewed through the transparent surface (e.g., in a see-through configuration). In some cases, XR device 102 may include a camera and may display both real-world objects (e.g., as frames or images captured by the camera) and virtual objects overlaid on the displayed real-world objects (e.g., in a pass-through configuration). In various examples, XR device 102 may include aspects of a virtual reality headset, smart glasses, a live feed video camera, a GPU, one or more sensors (e.g., such as one or more inertial measurement units (IMUs), image sensors, microphones, etc.), one or more output devices (e.g., such as speakers, display, smart glass, etc.), etc.

Companion device 104 may render the virtual content to be displayed by companion device 104. In some examples, companion device 104 may be, or may include, a smartphone, laptop, tablet computer, personal computer, gaming system, a server computer or server device (e.g., an edge or cloud-based server, a personal computer acting as a server device, or a mobile device acting as a server device), any other computing device and/or a combination thereof.

Communication link 106 may be a wired or wireless connection according to any suitable wireless protocol, such as, for example, universal serial bus (USB), ultra-wideband (UWB), Institute of Electrical and Electronics Engineers (IEEE) 802.11 (Wi-Fi), IEEE 802.15, or Bluetooth®. In some cases, communication link 106 may be a direct wireless connection between XR device 102 and companion device 104. In other cases, communication link 106 may be through one or more intermediary devices, such as, for example, routers or switches and/or across a network.

According to various aspects, XR device 102 may capture images and provide the captured images to companion device 104. Companion device 104 may implement detection, recognition, and/or tracking algorithms based on the captured images.

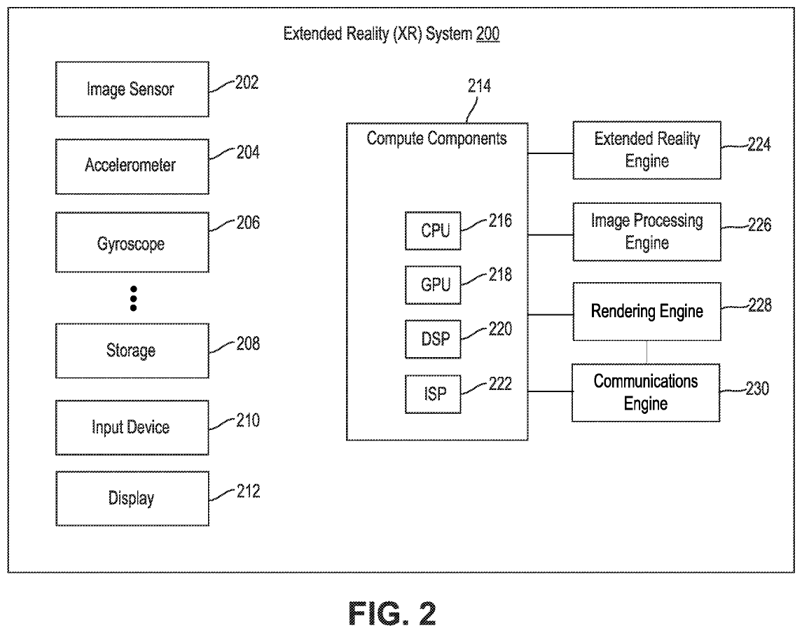

FIG. 1B is a perspective diagram 100b illustrating a head-mounted display (HMD) 120, in accordance with some examples. The HMD 120 may be, for example, an augmented reality (AR) headset, a virtual reality (VR) headset, a mixed reality (MR) headset, an extended reality (XR) headset, or some combination thereof. The HMD 120 may be an example of an XR system, such as the XR system 200 of FIG. 2. The HMD 120 includes a first camera 130A and a second camera 130B along a front portion of the HMD 120. In some examples, the HMD 120 may only have a single camera. In some examples, the HMD 120 may include one or more additional cameras in addition to the first camera 130A and the second camera 130B. In some examples, the HMD 120 may include one or more additional sensors in addition to the first camera 130A and the second camera 130B.

FIG. 1C is a perspective diagram 100c illustrating the head-mounted display (HMD) 120 of FIG. 1B being worn by a user 150, in accordance with some examples. The user 150 wears the HMD 120 on the user 150's head over the user 150's eyes. The HMD 120 can capture images with the first camera 130A and the second camera 130B. In some examples, the HMD 120 displays one or more display images toward the user 150's eyes that are based on the images captured by the first camera 130A and the second camera 130B. The display images may provide a stereoscopic view of the environment, in some cases with information overlaid and/or with other modifications. For example, the HMD 120 can display a first display image to the user 150's right eye, the first display image based on an image captured by the first camera 130A. The HMD 120 can display a second display image to the user 150's left eye, the second display image based on an image captured by the second camera 130B. For instance, the HMD 120 may provide overlaid information in the display images overlaid over the images captured by the first camera 130A and the second camera 130B.

The HMD 120 may include no wheels, propellers or other conveyance of its own. Instead, the HMD 120 relies on the movements of the user 150 to move the HMD 120 about the environment. In some cases, for instance where the HMD 120 is a VR headset, the environment may be entirely or partially virtual. If the environment is at least partially virtual, then movement through the virtual environment may be virtual as well. For instance, movement through the virtual environment can be controlled by an input device. The movement actuator may include any such input device. Movement through the virtual environment may not require wheels, propellers, legs, or any other form of conveyance. In some cases, feature tracking and/or SLAM may be performed in a virtual environment even by a vehicle or other device that has its own physical conveyance system that allows it to physically move about a physical environment.

FIG. 2 is a diagram illustrating an architecture of an example extended reality (XR) system 200, in accordance with some examples. XR system 200 may execute XR applications and implement XR operations. In this illustrative example, XR system 200 includes one or more image sensors 202, an accelerometer 204, a gyroscope 206, storage 208, an input device 207, a display 212, compute components 214, an XR engine 224, an image processing engine 226, a rendering engine 228, and a communications engine 230. It should be noted that the components 202-230 shown in FIG. 2 are non-limiting examples provided for illustrative and explanation purposes, and other examples may include more, fewer, or different components than those shown in FIG. 2. For example, in some cases, XR system 200 may include one or more other sensors (e.g., one or more inertial measurement units (IMUs), radars, light detection and ranging (LIDAR) sensors, radio detection and ranging (RADAR) sensors, sound detection and ranging (SODAR) sensors, sound navigation and ranging (SONAR) sensors. audio sensors, etc.), one or more display devices, one more other processing engines, one or more other hardware components, and/or one or more other software and/or hardware components that are not shown in FIG. 2. While various components of XR system 200, such as image sensor 202, may be referenced in the singular form herein, it should be understood that XR system 200 may include multiple of any component discussed herein (e.g., multiple image sensors 202).

Display 212 may be, or may include, a glass, a screen, a lens, a projector, and/or other display mechanism that allows a user to see the real-world environment and also allows XR content to be overlaid, overlapped, blended with, or otherwise displayed thereon.

XR system 200 may include, or may be in communication with, (wired or wirelessly) an input device 210. Input device 210 may include any suitable input device, such as a touchscreen, a pen or other pointer device, a keyboard, a mouse a button or key, a microphone for receiving voice commands, a gesture input device for receiving gesture commands, a video game controller, a steering wheel, a joystick, a set of buttons, a trackball, a remote control, any other input device discussed herein, or any combination thereof. In some cases, image sensor 202 may capture images that may be processed for interpreting gesture commands.

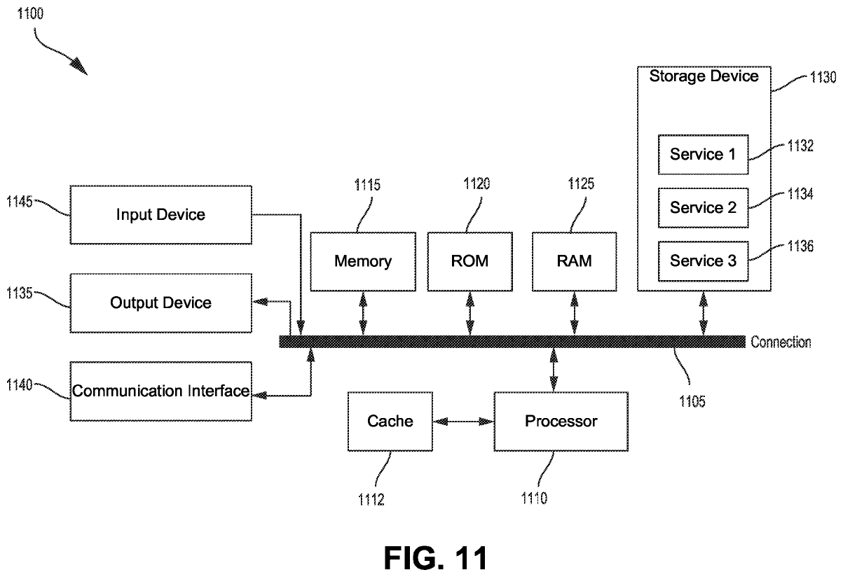

XR system 200 may also communicate with one or more other electronic devices (wired or wirelessly). For example, communications engine 230 may be configured to manage connections and communicate with one or more electronic devices. In some cases, communications engine 230 may correspond to communication interface 1140 of FIG. 11.

In some implementations, image sensors 202, accelerometer 204, gyroscope 206, storage 208, display 212, compute components 214, XR engine 224, image processing engine 226, and rendering engine 228 may be part of the same device. For example, in some cases, image sensors 202, accelerometer 204, gyroscope 206, storage 208, display 212, compute components 214, XR engine 224, image processing engine 226, and rendering engine 228 may be integrated into an HMD, extended reality glasses, smartphone, laptop, tablet computer, gaming system, and/or any other computing device. However, in some implementations, image sensors 202, accelerometer 204, gyroscope 206, storage 208, display 212, compute components 214, XR engine 224, image processing engine 226, and rendering engine 228 may be part of two or more separate computing devices. For instance, in some cases, some of the components 202-230 may be part of, or implemented by, one computing device and the remaining components may be part of, or implemented by, one or more other computing devices. For example, such as in a split perception XR system, XR system 200 may include a first device (e.g., an XR device such as XR device 102 of FIG. 1A, HMD 120 of FIGS. 1B and 1C, etc.), including display 212, image sensor 202, accelerometer 204, gyroscope 206, and/or one or more compute components 214. XR system 200 may also include a second device including additional compute components 214 (e.g., implementing XR engine 224, image processing engine 226, rendering engine 228, and/or communications engine 230). In such an example, the second device may generate virtual content based on information or data (e.g., images, sensor data such as measurements from accelerometer 204 and gyroscope 206) and may provide the virtual content to the first device for display at the first device. The second device may be, or may include, a smartphone, laptop, tablet computer, personal computer, gaming system, a server computer or server device (e.g., an edge or cloud-based server, a personal computer acting as a server device, or a mobile device acting as a server device), any other computing device and/or a combination thereof.

Storage 208 may be any storage device(s) for storing data. Moreover, storage 208 may store data from any of the components of XR system 200. For example, storage 208 may store data from image sensor 202 (e.g., image or video data), data from accelerometer 204 (e.g., measurements), data from gyroscope 206 (e.g., measurements), data from compute components 214 (e.g., processing parameters, preferences, virtual content, rendering content, scene maps, tracking and localization data, object detection data, privacy data, XR application data, face recognition data, occlusion data, etc.), data from XR engine 224, data from image processing engine 226, and/or data from rendering engine 228 (e.g., output frames). In some examples, storage 208 may include a buffer for storing frames for processing by compute components 214.

Compute components 214 may be, or may include, a central processing unit (CPU) 216, a graphics processing unit (GPU) 218, a digital signal processor (DSP) 220, an image signal processor (ISP) 222, and/or other processor (e.g., a neural processing unit (NPU) implementing one or more trained neural networks). Compute components 214 may perform various operations such as image enhancement, computer vision, graphics rendering, extended reality operations (e.g., tracking, localization, pose estimation, mapping, content anchoring, content rendering, predicting, etc.), image and/or video processing, sensor processing, recognition (e.g., text recognition, facial recognition, object recognition, feature recognition, tracking or pattern recognition, scene recognition, occlusion detection, etc.), trained machine-learning operations, filtering, and/or any of the various operations described herein. In some examples, compute components 214 may implement (e.g., control, operate, etc.) XR engine 224, image processing engine 226, and rendering engine 228. In other examples, compute components 214 may also implement one or more other processing engines.

Image sensor 202 may include any image and/or video sensors or capturing devices. In some examples, image sensor 202 may be part of a multiple-camera assembly, such as a dual-camera assembly. Image sensor 202 may capture image and/or video content (e.g., raw image and/or video data), which may then be processed by compute components 214, XR engine 224, image processing engine 226, and/or rendering engine 228 as described herein.

In some examples, image sensor 202 may capture image data and may generate images (also referred to as frames) based on the image data and/or may provide the image data or frames to XR engine 224, image processing engine 226, and/or rendering engine 228 for processing. An image or frame may include a video frame of a video sequence or a still image. An image or frame may include a pixel array representing a scene. For example, an image may be a red-green-blue (RGB) image having red, green, and blue color components per pixel; a luma, chroma-red, chroma-blue (YCbCr) image having a luma component and two chroma (color) components (chroma-red and chroma-blue) per pixel; or any other suitable type of color or monochrome image.

In some cases, image sensor 202 (and/or other camera of XR system 200) may be configured to also capture depth information. For example, in some implementations, image sensor 202 (and/or other camera) may include an RGB-depth (RGB-D) camera. In some cases, XR system 200 may include one or more depth sensors (not shown) that are separate from image sensor 202 (and/or other camera) and that may capture depth information. For instance, such a depth sensor may obtain depth information independently from image sensor 202. In some examples, a depth sensor may be physically installed in the same general location or position as image sensor 202, but may operate at a different frequency or frame rate from image sensor 202. In some examples, a depth sensor may take the form of a light source that may project a structured or textured light pattern, which may include one or more narrow bands of light, onto one or more objects in a scene. Depth information may then be obtained by exploiting geometrical distortions of the projected pattern caused by the surface shape of the object. In one example, depth information may be obtained from stereo sensors such as a combination of an infra-red structured light projector and an infra-red camera registered to a camera (e.g., an RGB camera).

XR system 200 may also include other sensors in its one or more sensors. The one or more sensors may include one or more accelerometers (e.g., accelerometer 204), one or more gyroscopes (e.g., gyroscope 206), and/or other sensors. The one or more sensors may provide velocity, orientation, and/or other position-related information to compute components 214. For example, accelerometer 204 may detect acceleration by XR system 200 and may generate acceleration measurements based on the detected acceleration. In some cases, accelerometer 204 may provide one or more translational vectors (e.g., up/down, left/right, forward/back) that may be used for determining a position or pose of XR system 200. Gyroscope 206 may detect and measure the orientation and angular velocity of XR system 200. For example, gyroscope 206 may be used to measure the pitch, roll, and yaw of XR system 200. In some cases, gyroscope 206 may provide one or more rotational vectors (e.g., pitch, yaw, roll). In some examples, image sensor 202 and/or XR engine 224 may use measurements obtained by accelerometer 204 (e.g., one or more translational vectors) and/or gyroscope 206 (e.g., one or more rotational vectors) to calculate the pose of XR system 200. As previously noted, in other examples, XR system 200 may also include other sensors, such as an inertial measurement unit (IMU), a magnetometer, a gaze and/or eye tracking sensor, a machine vision sensor, a smart scene sensor, a speech recognition sensor, an impact sensor, a shock sensor, a position sensor, a tilt sensor, etc.

As noted above, in some cases, the one or more sensors may include at least one IMU. An IMU is an electronic device that measures the specific force, angular rate, and/or the orientation of XR system 200, using a combination of one or more accelerometers, one or more gyroscopes, and/or one or more magnetometers. In some examples, the one or more sensors may output measured information associated with the capture of an image captured by image sensor 202 (and/or other camera of XR system 200) and/or depth information obtained using one or more depth sensors of XR system 200.

The output of one or more sensors (e.g., accelerometer 204, gyroscope 206, one or more IMUs, and/or other sensors) can be used by XR engine 224 to determine a pose of XR system 200 (also referred to as the head pose) and/or the pose of image sensor 202 (or other camera of XR system 200). In some cases, the pose of XR system 200 and the pose of image sensor 202 (or other camera) can be the same. The pose of image sensor 202 refers to the position and orientation of image sensor 202 relative to a frame of reference (e.g., with respect to a field of view 110 of FIG. 1A). In some implementations, the camera pose can be determined for 6-Degrees Of Freedom (6 DoF), which refers to three translational components (e.g., which can be given by X (horizontal), Y (vertical), and Z (depth) coordinates relative to a frame of reference, such as the image plane) and three angular components (e.g., roll, pitch, and yaw relative to the same frame of reference). In some implementations, the camera pose can be determined for 3-Degrees Of Freedom (3 DoF), which refers to the three angular components (e.g., roll, pitch, and yaw).

In some cases, a device tracker (not shown) can use the measurements from the one or more sensors and image data from image sensor 202 to track a pose (e.g., a 6 DoF pose) of XR system 200. For example, the device tracker can fuse visual data (e.g., using a visual tracking solution) from the image data with inertial data from the measurements to determine a position and motion of XR system 200 relative to the physical world (e.g., the scene) and a map of the physical world. As described below, in some examples, when tracking the pose of XR system 200, the device tracker can generate a three-dimensional (3D) map of the scene (e.g., the real world) and/or generate updates for a 3D map of the scene. The 3D map updates can include, for example and without limitation, new or updated features and/or feature or landmark points associated with the scene and/or the 3D map of the scene, localization updates identifying or updating a position of XR system 200 within the scene and the 3D map of the scene, etc. The 3D map can provide a digital representation of a scene in the real/physical world. In some examples, the 3D map can anchor position-based objects and/or content to real-world coordinates and/or objects. XR system 200 can use a mapped scene (e.g., a scene in the physical world represented by, and/or associated with, a 3D map) to merge the physical and virtual worlds and/or merge virtual content or objects with the physical environment.

In some aspects, the pose of image sensor 202 and/or XR system 200 as a whole can be determined and/or tracked by compute components 214 using a visual tracking solution based on images captured by image sensor 202 (and/or other camera of XR system 200). For instance, in some examples, compute components 214 can perform tracking using computer vision-based tracking, model-based tracking, and/or simultaneous localization and mapping (SLAM) techniques. For instance, compute components 214 can perform SLAM or can be in communication (wired or wireless) with a SLAM system (not shown). SLAM refers to a class of techniques where a map of an environment (e.g., a map of an environment being modeled by XR system 200) is created while simultaneously tracking the pose of a camera (e.g., image sensor 202) and/or XR system 200 relative to that map. The map can be referred to as a SLAM map and can be three-dimensional (3D). The SLAM techniques can be performed using color or grayscale image data captured by image sensor 202 (and/or other camera of XR system 200) and can be used to generate estimates of 6 DoF pose measurements of image sensor 202 and/or XR system 200. Such a SLAM technique configured to perform 6 DoF tracking can be referred to as 6 DoF SLAM. In some cases, the output of the one or more sensors (e.g., accelerometer 204, gyroscope 206, one or more IMUs, and/or other sensors) can be used to estimate, correct, and/or otherwise adjust the estimated pose.

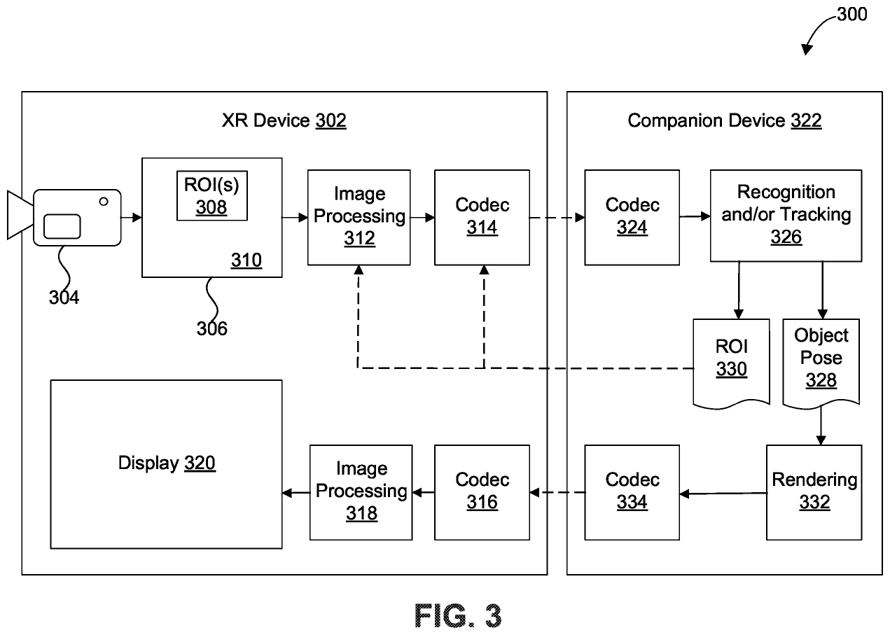

FIG. 3 is a block diagram illustrating an example extended reality (XR) system 300, in accordance with some examples. XR system 300 may include an XR device 302 and a companion device 322. XR device 302 may be a head-borne device (e.g., an HMD, smart glasses, or the like). XR device 302 may be an example of XR device 102 of FIG. 1A, HMD 120 of FIGS. 1B and 1C, etc. Companion device 322 may be, may be included in, or may be implemented in a computing device, such as a mobile phone, a tablet, a laptop, a personal computer, a server, a computing system of a vehicle, or other computing device. Companion device 322 may be an example of companion device 104 of FIG. 1A.

The XR device 302 includes an image-capture device 304 that may capture one or more images 306 (e.g., the image-capture device may capture image(s) 306 continuously). Image(s) 306 may be, or may include, single-view images (e.g., monocular images) or multi-view images (e.g., stereoscopically paired images). Image(s) 306 may include one or more regions of interest (ROIs) 308 and one more non-region-of-interest portions 310. When image(s) 306 are captured, XR device 302 may, or may not, distinguish between region(s) of interest 308 and non-region-of-interest portion(s) 310. According to a first example, XR device 302 may identify region(s) of interests 308 (e.g., based on a gaze of the user based on images captured by another camera directed towards the eyes of the user (not illustrated in FIG. 3)). According to a second example, companion device 322 may identify region(s) of interests 308 within image(s) 306 according to one or more techniques (as will be described with more detail below) and provide ROI information 330 indicative of region(s) of interest 308 to XR device 302. XR device 302 may parse newly-captured image(s) 306 according to region(s) of interest 308 determined by companion device 322 based on previously-captured image(s) 306. For example, XR device 302 may identify pixels in the newly-captured image(s) 306 that correlate to the region(s) of interest 308 identified based on previously-captured image(s) 306.

XR device 302 may process image(s) 306 at an image-processing engine 312. Image-processing engine 312 may be a circuit or a chip (e.g., a field-programmable gate array (FPGA) or an image processor). Image-processing engine 312 may, among other things, filter image(s) 306 (e.g., to remove noise). In some cases, image-processing engine 312 may receive ROI information 330 and apply a low-pass filter to non-region-of-interest portion(s) 310 of image(s) 306. Applying the low-pass filter may remove high-frequency spatial content from the image data which may allow the image data to be encoded (e.g., by an encoder 314) using fewer bits per pixel. Applying a low-pass filter to an image may have the effect of blurring the image. Because the low-pass filter is applied to non-region-of-interest portion(s) 310, and not to region(s) of interest 308, companion device 322 may not be impaired in its ability to detect, recognize, and/or track objects in region(s) of interest 308 of image(s) 306.

Image-processing engine 312 may provide processed image data to encoder 314 (which may be a combined encoding-decoding device, also referred to as a codec). Encoder 314 may be, or may implemented in, a circuit or a chip (e.g., an FPGA or a processor). Encoder 314 may encode the processed image data for transmission (e.g., as individual data packets for sequential transmission). In one illustrative example, encoder 314 can encode the image data based on a video coding standard, such as High-Efficiency Video Coding (HEVC), Versatile Video Coding (VVC), or another video coding standard. In another illustrative example, encoder 314 can encode the image data using a machine-learning system that is trained to encode images (e.g., trained using supervised, semi-supervised, or self-supervised learning techniques).

Encoder 314 may receive ROI information 330 and may, while encoding the image data, use different parameters (e.g., different quantization parameters (QPs)) when encoding the region(s) of interest 308 and non-region-of-interest portion(s) 310 of image(s) 306. Encoder 314 may support a quantization-parameter map having a block granularity. For example, encoder 314 may use a first QP to encode the region(s) of interest 308 and a second QP (e.g., higher than the first QP) to encode non-region-of-interest portion(s) 310 of image(s) 306. By encoding non-region-of-interest portion(s) 310 of the image data using the second (e.g., higher) QP, encoder 314 may generate encoded data that is more dense (e.g., comprised of fewer bits) than the encoded data would be if the first QP were used to encode the entirety of each of image(s) 306. For instance, because the image data is encoded using higher QPs to encode non-region-of-interest portion(s) 310 of image(s) 306, the encoded data may represent image(s) 306 using fewer bits than if the entirety of each of image(s) 306 were encoded using the first QP. Identifying region(s) of interest 308, and not using higher QPs for the region(s) of interest 308 may ensure that region(s) of interest 308 retain their original image quality, thus leaving object detect, recognition, and/or tracking abilities of companion device 322 unimpaired.

Additionally, or alternatively, image-processing engine 312 or encoder 314 may apply a mask to non-region-of-interest portion(s) 310 of image(s) 306 prior to encoding the image data. Such a mask may render non-region-of-interest portion(s) 310 as a uniform value (e.g., an average intensity of image(s) 306). Masking non-region-of-interest portion(s) 310 of image(s) 306 using a uniform value may cause the resulting image data to be encoded using fewer bits per pixel, for example, because the uniform values may be coded with skip mode.

Filtering the image data, or masking the image data, may provide an additional benefit if the data is subsequently encoded using different QPs. For example, applying different QPs while encoding may introduce artifacts into images (e.g., at quantization-difference boundaries). Applying a low-pass filter or mask may limit or decrease such artifacts.

Additionally, or alternatively, pixels of region(s) of interest 308 may be padded, which may reduce artificial discontinuities and/or enhance compression gain and/or subjective quality of region(s) of interest 308 in reconstructed images. Additionally, or alternatively, non-region-of-interest portion(s) 310 may be intra coded, which may reduce dynamic random access memory traffic.

In some cases, if an object being tracked is very close to image-capture device 304, the object may occupy a large portion of image(s) 306. A tracker algorithm may be able to work with lower quality images of the object (e.g., images encoded using a relatively high QP and/or images that were filtered) because features of the object may be easily detected and/or tracked because the object occupies a large portion of image(s) 306. In such cases the large portion of image(s) 306 occupied by the object can be encoded using a higher QP and/or can be filtered to conserver bandwidth.

Additionally, or alternatively, a QP (and/or low-pass filter passband) may be determined based on an inverse relationship with a distance between an object represented by region(s) of interest 308 and image-capture device 304. The distance between the object and the image-capture device 304 may be determined by companion device 322 (e.g., based on a stereoscopic image and/or a distance sensor of companion device 322). As an example, the farther away an object is from image-capture device 304, the lower the QP selected for encoding a region(s) of interest 308 representing the object may be. As another example, the farther away an object is from image-capture device 304, the larger the passband of the low-pass filter selected for filtering a region(s) of interest 308 representing the object may be. In some cases, QPs and/or passbands may be determined by recognition and/or tracking engine 326 (e.g., such that objects in region(s) of interest 308 of reconstructed images can be detected, recognized, and/or tracked).

After encoding the image data, XR device 302 may transmit the encoded data to companion device 322 (e.g., using a communication engine which is not illustrated in FIG. 3). The encoded data may include relatively few bits (e.g., based on the low-pass filtering of the image data, encoding portions of the image data using a relatively high QP, or masking the image data). In other words, the encoded data may include fewer bits than if the entire image were encoded using a low QP, not filtered, and not masked. The encoded data, including relatively few bits, can be transmitted using less bandwidth than would be used to transmit data encoded without low-pass filtering, using a relatively high QP for portions of the image data, and/or masking. Conserving bandwidth at XR device 302 may conserve power at XR device 302.

Companion device 322 may receive the encoded data (e.g., using a communication engine which is not illustrated in FIG. 3) and provide the encoded data to decoder 324. The line between encoder 314 and decoder 324 is illustrated using a dashed line to indicate that the communication of the encoded image data between encoder 314 and decoder 324 may be wired or wireless, for example, according to any suitable communication protocol such as, USB, UWB, Wi-Fi, IEEE 902.15, or Bluetooth®. Similarly, other lines between XR device 302 and companion device 322 (including the line between ROI information 330 and image-processing engine 312, the line between ROI information 330 and encoder 314, and the line between encoder 334 and decoder 316) are illustrated using dashed lines to indicate that the communications represented by such lines may be wired or wireless.

Decoder 324 (which may be a codec) may decode the encoded image data. Decoder 324 may be, or may implemented in, a circuit or a chip (e.g., an FPGA or a processor). The decoded image data may not be the same as image(s) 306. For example, the decoded image data may be different from image(s) 306 based on image-processing engine 312 applying a low-pass filter to the image data and/or applying a mask before encoding the image data and/or based on decoder 324 applying different QPs to the image data while encoding the image data. Nevertheless, based on image-processing engine 312 filtering and/or masking non-region-of-interest portion(s) 310 and not region(s) of interest 308, and/or based on encoder 314 using a relatively low QP when encoding region(s) of interest 308, region(s) of interest 308 may be substantially the same in the decoded image data as in image(s) 306.

Recognition and/or tracking engine 326 (which may be, or may implemented in, a circuit or a chip (e.g., an FPGA or a processor)) may receive the decoded image data and perform operations related to: object detection, object recognition, object tracking, hand tracking, semantic segmentation, saliency detection, and/or other computer-vision tasks using the decoded image data. For example, recognition and/or tracking engine 326 may identify region(s) of interest 308 based on based on an object-recognition technique (e.g., identifying an object represented in image(s) 306 and tracking the position of the object through multiple image(s) 306). As another example, recognition and/or tracking engine 326 may identify region(s) of interest 308 based on a hand-tracking technique (e.g., identifying a hand as a region of interest 308 and/or identifying a region of interest 308 using a hand as an indicator, such as the hand pointing at the region of interest 308). As another example, recognition and/or tracking engine 326 may identify region(s) of interest 308 based on a semantic-segmentation technique or a saliency-detection technique (e.g., determining important regions of image(s) 306).

Recognition and/or tracking engine 326 may identify region(s) of interest 308 so that recognition and/or tracking engine 326 can track objects in region(s) of interests 308. Region(s) of interest 308 may be related to objects detected and/or tracked by recognition and/or tracking engine 326. For example, region(s) of interest 308 may be bounding boxes including the detected and/or tracked objects.

Recognition and/or tracking engine 326 may generate ROI information 330 indicative of the determined region(s) of interest 308 and provide ROI information 330 to image-processing engine 312 and/or encoder 314. Additionally, or alternatively, recognition and/or tracking engine 326 may determine object pose 328. Object pose 328 may be indicative of a position and/or orientation of objects detected and/or tracked by recognition and/or tracking engine 326.

Rendering 332 (which may be, or may implemented in, a circuit or a chip (e.g., an FPGA or a processor)) may receive object pose 328 from recognition and/or tracking engine 326 and may render images for display by XR device 302 based on object pose 328. For example, rendering 332 may determine where in a display 320 of XR device 302 to display virtual content based on object pose 328. As an example, rendering 332 may determine to display virtual content to overlay tracked real-world objects within a field of view of a user.

Rendering 332 may provide the rendered images to encoder 334. In some cases, encoder 334 and decoder 324 may be included in the same circuit or chip. In other cases, encoder 334 may be independent of decoder 324. In any case, encoder 334 may be, or may implemented in, a circuit or a chip (e.g., an FPGA or a processor). Encoder 334 may encode the image data from rendering 332 for transmission (e.g., as individual data packets for sequential transmission). In one illustrative example, encoder 334 can encode the image data based on a video coding standard, such as HEVC, VVC, or another video coding standard. In another illustrative example, encoder 334 can encode the image data using a machine-learning system that is trained to encode images (e.g., trained using supervised, semi-supervised, or self-supervised learning techniques).

After encoding the image data, companion device 322 may transmit the encoded data to XR device 302 (e.g., using a communication engine which is not illustrated in FIG. 3). XR device 302 may receive the encoded data (e.g., using a communication engine which is not illustrated in FIG. 3) and decode the encoded data at a decoder 316. In some cases, decoder 316 and encoder 314 may be included in the same circuit or chip. In other cases, decoder 316 may be independent of encoder 314. In any case, decoder 316 may be, or may implemented in, a circuit or a chip (e.g., an FPGA or a processor).

Image-processing engine 318 may receive the decoded image data from decoder 316 and process the decoded images data. For example, image-processing engine 318 may perform one or more of: color conversion, error concealment, and/or image warping for display-time head pose (which may also be referred to in the art as late stage reprojection). Display 320 may receive the processed image data from image-processing engine 318 and display the image data.

In some cases, XR device 302 may periodically transmit additional image data entirely encoded using the one QP (e.g., a relatively low QP), without low-pass filtering or masking. Such images may allow recognition and/or tracking engine 326 to detect objects and/or identify additional region(s) of interest 308 or update region(s) of interest 308. Additionally, or alternatively, in some cases, recognition and/or tracking engine 326 may request that XR device 302 capture and send one or more image(s) 306 encoded using a relatively low QP and/or without low-pass filtering. Recognition and/or tracking engine 326 may request such image(s) 306 based on determining a possibility that a new object may be represented in such image(s) 306.

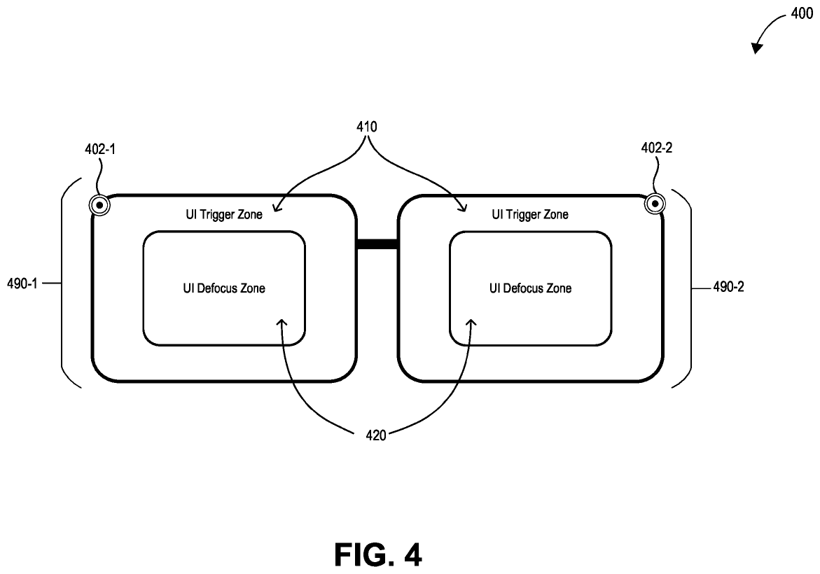

As noted previously, systems and techniques are described herein that can be used for XR device (e.g., smart glasses) device management using one or more eye tracking sensors and/or gaze direction information of a user or wearer of the XR device. FIG. 4 is a diagram illustrating an example of an XR system 400 with one or more user interface (UI) trigger zones and one or more UI defocus zones, in accordance with some examples. For instance, in one illustrative example, the XR system 400 can be implemented using smart glasses that include a first (e.g., left) transparent pane 490-1 and a second (e.g., right) transparent pane 490-2. The left transparent pane 490-1 can correspond, in some examples, to a left lens assembly of the smart glasses. The right transparent pane 490-2 can correspond, in some examples, to a right lens assembly of the smart glasses. In some aspects, the XR system 400 can be implemented using smart glasses that are the same as or similar to one or more of the XR device 102 of FIG. 1A, the HMD 120 of FIG. 1B and FIG. 1C; smart glasses implementing the XR system 200 of FIG. 2; the XR device 302 of FIG. 3; etc.

In some examples, the smart glasses can implement a graphical user interface (GUI) through the left and right transparent panes 490-1, 490-2 (e.g., lenses or displays) of the smart glasses as an overlay. For example, a GUI can be overlayed on top of the field of vision or field of view (FOV) of the wearer. In some cases, a GUI overlay on top of the wearer's FOV may distract the wearer, occlude the wearer's vision, etc. In some cases, smart glasses may be worn for an extended duration or prolonged period of time. There is a need for systems and techniques that can be used to provide improved GUI management for smart glasses and other XR devices to reduce or minimize user distraction from the GUI. Examples of smart glasses GUI elements can include one or more of notifications, dynamic GUI components, which may occlude the field of vision of the wearer etc.

In some examples, a virtual GUI overlay can include one or more GUI elements such as the velocity at which the wearer is moving; battery charge levels of the smart glasses; network connectivity and signal strength status; navigation guidance or pointers; any notifications from another smart device such as a smartphone or health tracker device, which is paired to the smart glasses via a wired or wireless link; etc.

As mentioned previously, in some aspects a direction of gaze can be determined using one or more cameras that monitor the eyes of the smart glasses wearer. For instance, the one or more cameras can be provided in the smart glasses frame and oriented towards the eyes of the smart glasses wearer (e.g., user). In one illustrative example, the XR system (e.g., smart glasses) 400 of FIG. 4 can include at least one eye tracking camera 402-1 associated with the left eye of the user and located on or about the left transparent pane 490-1 of the smart glasses 400, and at least one eye tracking camera 402-2 associated with the right eye of the user and located on or about the right transparent pane 490-2 of the smart glasses 400.

Each of the smart glasses lens areas (e.g., the left and right transparent panes 490-1 and 490-2, respectively) can be divided into different zones (e.g., also referred to as “areas,” “regions,” “sub-areas,” etc.). For instance, the smart glasses lens area or viewing area can include a first portion corresponding to a UI defocus zone and a second portion corresponding to a UI trigger zone. As illustrated, the left and right transparent panes of the smart glasses 400 can each include a respective UI trigger zone 410 and a respective UI defocus zone 420. In some aspects, the UI trigger zone 410 implemented for the left transparent pane 490-1 can be the same as the UI trigger zone 410 implemented for the right transparent pane 490-2, and the UI defocus zone 420 implemented for the left transparent pane 490-1 can be the same as the UI defocus zone 420 implemented for the right transparent pane 490-2. In some examples, the left and right transparent panes can implement respective UI defocus zones 420 that are different from one another and/or can implement respective UI trigger zones that are different from one another.

In some examples, the UI trigger zone 410 and/or the UI defocus zone 420 can be implemented as a pre-determined or configured sub-area of a larger area associated with one of the left transparent pane 490-1 or the right transparent pane 490-2. For instance, the UI trigger zone 410 can comprise a first sub-area of the respective area of the left transparent pane 490-1 and the right transparent pane 490-2. The UI defocus zone can comprise a second sub-area of the respective area of the left transparent pane 490-1 and the right transparent pane 490-2. In some aspects, the UI trigger zone 410 and the UI defocus zone 420 are non-overlapping (e.g., mutually exclusive) from one another. In some examples, the sum of the sub-area of the UI trigger zone 410 and the sub-area of the UI defocus zone 420 can be equal to the area of the left and right transparent panes 490-1, 490-2 (respectively). In some examples, the location and/or size (e.g., area) of the UI defocus zone 420 and/or the UI trigger zone 410 can vary based on the location(s) of the eye tracking cameras 402-1, 402-2 and/or an eye tracking framework that includes at least the eye tracking cameras 402-1, 402-2. In some cases, the systems and techniques described herein can be used to detect the zone (e.g., UI trigger zone 410, UI defocus zone 420, etc.) at which a gaze of the user is directed, for instance based on using data obtained from the one or more eye tracking cameras 402-1, 402-2 provided on the XR device (e.g., smart glasses).

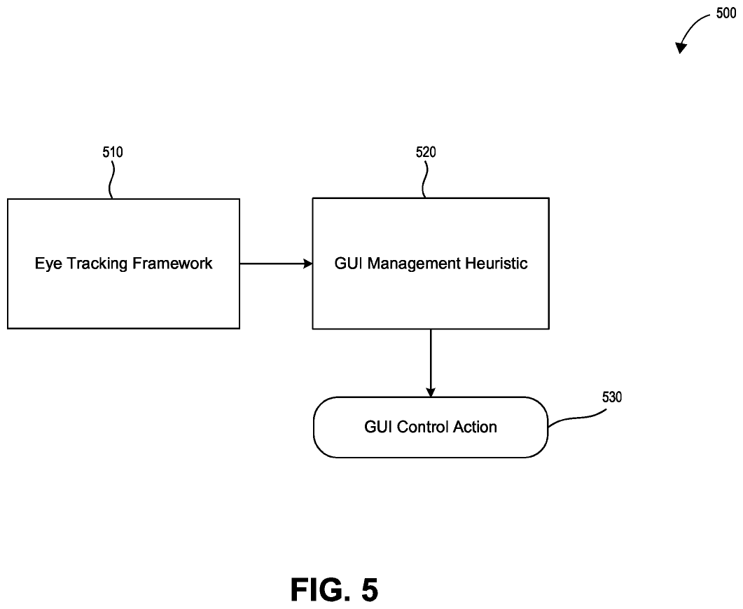

FIG. 5 is a diagram illustrating an example of eye tracking GUI management system 500, in accordance with some examples. The eye tracking GUI management system 500 can include an eye tracking framework 510 (e.g., also referred to herein as an “eye tracking engine” 510) and one or more GUI management heuristics 520 (e.g., also referred to herein as a “GUI management heuristic engine” 520 and/or a “GUI management engine” 520). The eye tracking GUI management system 500 can be used to determine one or more GUI control actions 530 for controlling and/or rendering a GUI displayed on an XR device based on determining direction of gaze information for a user (e.g., wearer) of the XR device.

In some aspects, a smart heuristic (e.g., the GUI management heuristic 520) can be used to implement GUI management based on identifying or detecting a particular region towards which the XR device user's gaze is directed. For instance, the GUI management heuristic 520 can identify or detect a particular region or sub-region (e.g., such as the UI trigger zone 410 or UI defocus zone 420 of FIG. 4) of an XR device display output that corresponds to the user's direction of gaze. The GUI management heuristic 520 can perform UI management (e.g., GUI management) based on at least gaze direction information. For instance, the GUI management heuristic 520 can receive, from the eye tracking framework 510, information indicative of a direction of gaze of the user. The direction of gaze information can correspond to both the right and left eyes of the user and/or can correspond separately to the right eye and the left eye of the user. Based on the direction of gaze information received from the eye tracking framework 510, the GUI management heuristic 520 can determine one or more actions to take for the virtual content being displayed on the smart glasses (e.g., the GUI management heuristic 520 can determine and/or generate as output the one or more GUI control actions 530, based on the direction of gaze information received from the eye tracking framework 510).

In some examples, the eye tracking framework 510 can be implemented by smart glasses or various other XR devices (e.g., such as the XR device 102 of FIG. 1A; the HMD 120 of FIG. 1B and FIG. 1C; smart glasses implementing the XR system 200 of FIG. 2; the XR device 302 of FIG. 3; etc.) In some examples, the eye tracking framework 510 of FIG. 5 can include or be associated with one or more eye tracking cameras of the XR device. For instance, the eye tracking framework 510 can include or be associated with the cameras 130A, 130B of the HMD 120 of FIGS. 1B and 1C; image sensor 202 of XR system 200 of FIG. 2; camera 304 of XR device 302 of FIG. 3; eye tracking cameras 402-1, 402-2 of the smart glasses 400 of FIG. 4; etc.

In some aspects, the GUI management system 500 of FIG. 5 (or one or more components thereof) can be implemented using one or more processors of the XR device. For example, GUI management system 500 can be implemented using the compute components 214 of the XR system 200 of FIG. 2, including one or more of the XR engine 223, image processing engine 226, rendering engine 228, and/or communications engine 230. In some cases, the eye tracking framework 510 can be implemented using the compute components 214 and one or more of the XR engine 224, image processing engine 226, and/or rendering engine 228 of the XR system 200 of FIG. 2, based on processing image data from the image sensors 202 and/or other sensor data obtained by sensors of the XR system 200. In some examples, the GUI management system 500 of FIG. 5 (or one or more components thereof) can be implemented using XR device 302 of FIG. 3. For instance, image data from camera 304 can be processed at image processing 312 and used to implement the eye tracking framework 510 of FIG. 5.

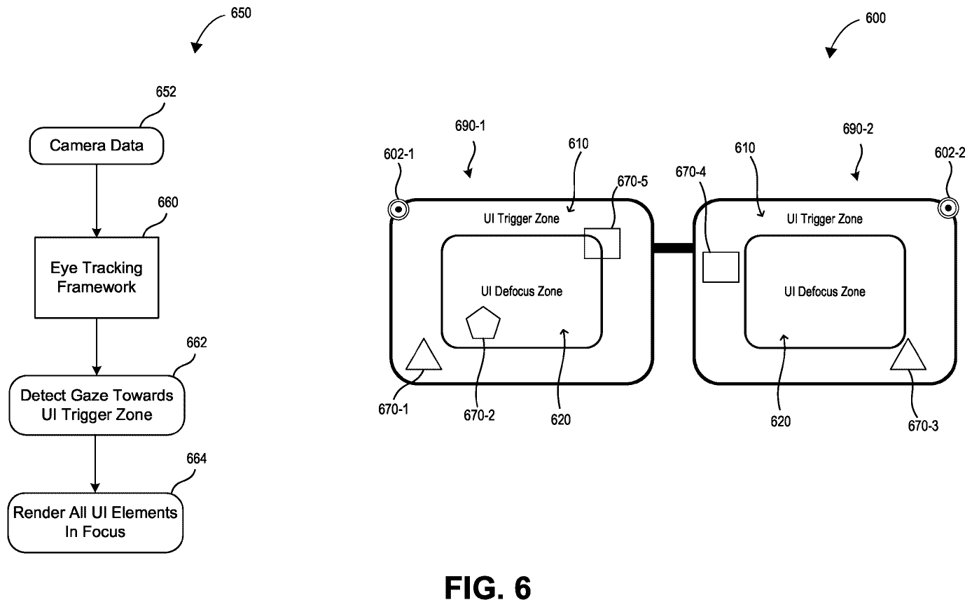

FIG. 6 is a diagram illustrating an example GUI rendering process 650 for an XR system 600 (e.g., smart glasses), where the example GUI rendering process 650 corresponds to a determination that an XR device user's direction of gaze is towards a UI trigger zone within a display of the XR system 600. In one illustrative example, the XR system 600 (e.g., also referred to herein as “smart glasses” 600) of FIG. 6 can be the same as or similar to the XR system 400 (e.g., smart glasses 400) of FIG. 4. For instance, the eye tracking cameras 602-1, 602-2 of FIG. 6 can be the same as or similar to the eye tracking cameras 402-1, 402-2 of FIG. 4; the UI trigger zone 610 of FIG. 6 can be the same as or similar to the UI trigger zone 410 of FIG. 4; the UI defocus zone 620 of FIG. 6 can be the same as or similar to the UI defocus zone 420 of FIG. 4; the left transparent pane 690-1 of FIG. 6 can be the same as or similar to the left transparent pane 490-1 of FIG. 4; the right transparent pane 690-2 of FIG. 6 can be the same as or similar to the right transparent pane 490-2 of FIG. 4; etc.

As noted above, the example GUI rendering process 650 can correspond to an example where a user's gaze is detected towards one (or both) of the respective left and right UI trigger zones 610. In some aspects, the GUI rendering process 650 of FIG. 6 can be implemented by the GUI management system 500 of FIG. 5. For example, the eye tracking framework 660 of FIG. 6 can be the same as or similar to the eye tracking framework 510 of FIG. 5. In some cases, block 664 of the GUI rendering process 650 (e.g., rendering all UI elements 670-1, 670-2, 670-3, 670-4, 670-5 in focus on the left and right transparent panes 690-1, 690-2) can correspond to the GUI control action 530 of FIG. 5. For example, block 664 of GUI rendering process 650 can be implemented by and/or using a GUI management heuristic that is the same as or similar to the GUI management heuristic 520 of FIG. 5.

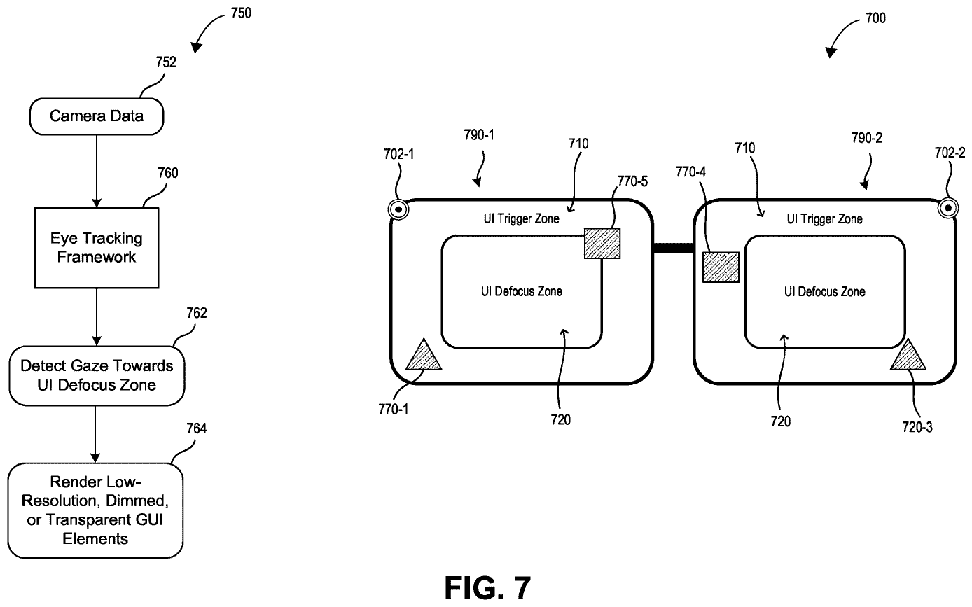

In one illustrative example, the GUI control action 530 that is determined and/or implemented by the GUI management heuristic 520 (e.g., also referred to as a “GUI control heuristic”) of FIG. 5 can correspond to an existing situation in which the XR device wearer is in. For instance, the GUI management heuristic 520 may determine that the user's gaze is directed towards a UI trigger zone based on the eye tracking framework 510 detecting the user's direction of gaze towards a UI trigger zone, or may determine that the user's gaze is directed towards a UI defocus zone based on the eye tracking framework 510 detecting the user's direction of gaze towards a UI defocus zone. In some aspects, the determination of user gaze towards a UI trigger zone can correspond to performing the GUI rendering process 650 of FIG. 6. The determination of user gaze towards a UI defocus zone can correspond to performing the GUI rendering process 750 of FIG. 7.

For example, the GUI rendering process 650 of FIG. 6 can include analyzing camera data 652 using the eye tracking framework 660. The camera data 652 can be obtained using the eye tracking cameras 602-1 and 602-2 of the XR device 600. The eye tracking framework 660 can be the same as or similar to the eye tracking framework 510 of FIG. 5. Based on analyzing the camera data 652, at block 662 of the GUI rendering process 650, the eye tracking framework 660 can generate information 662 indicative of detecting the user's direction of gaze towards the UI trigger zone 610. For instance, a user direction of gaze towards the UI trigger zone 610 corresponds to the user's gaze falling or being within the area of the UI trigger zone 610.

At block 664, the GUI rendering process 650 includes rendering all UI elements in focus on the display(s) of the XR device 600, where the in-focus rendering of all UI elements is based on the indication 662 of a detected user gaze direction towards UI trigger zone 610. In some aspects, the in-focus rendering of block 664 can correspond to a GUI control action (e.g., such as GUI control action 530 of FIG. 5). In some aspects, the in-focus rendering of all UI elements at block 664 of GUI rendering process 650 can be implemented based on using a GUI management heuristic (e.g., GUI management heuristic 520 of FIG. 5) to generate or configure a GUI control action causing the smart glasses 600 to display the whole GUI at full resolution. For instance, in the example of FIG. 6, each of the GUI elements 670-1, 670-2, 670-3, 670-4, 670-5 associated with (e.g., displayed on or within) a respective one of the left transparent pane 690-1 or the right transparent pane 690-2 are rendered in focus based on the eye tracking framework 660 detecting and/or determining the user's direction of gaze towards a UI trigger zone 610 at block 662. In some aspects, the plurality of GUI elements 670 can be rendered in focus and at full resolution. In one illustrative example, a subset of GUI elements located within the UI defocus zone 620 (e.g., GUI element 670-2) are rendered in focus; a subset of GUI elements located within the UI trigger zone 610 (e.g., GUI elements 670-1, 670-2, 670-4) are rendered in focus; and a subset of GUI elements located across both the UI defocus zone 620 and the UI trigger zone 610 (e.g., GUI element 670-5) are rendered in focus.

In another example, if the user's gaze is detected towards a UI trigger zone 410, 610, the GUI management heuristic 520 of FIG. 5 can generate or configure a GUI control action 530 causing the smart glasses 600 to display a first subset of the GUI (e.g., a first subset of GUI elements of the plurality of GUI elements 670) at full resolution. The first subset of GUI elements displayed at full resolution can be the GUI elements corresponding to a particular area or sub-area where the user's gaze is directed. In some aspects, the first subset of GUI elements displayed at full resolution comprises one or more GUI elements having a location that is the same as and/or within an area or sub-area where the user's gaze is directed. For instance, the first subset of GUI elements can be displayed at full resolution based on determining that the user's gaze is towards a particular area (e.g., sub-area) or a particular GUI element within UI trigger zone 610 (e.g., such as GUI element 670-2). The particular GUI element within the UI trigger zone 610 can be a GUI element that is included in the first subset of GUI elements. In another example, the particular GUI element can be a GUI trigger element, where a user direction of gaze at the GUI trigger element (e.g., within the UI trigger zone 610) causes the smart glasses 600 to render and display the corresponding first subset of GUI elements. The first subset of GUI elements corresponding to the particular GUI trigger element can be pre-determined and/or user-configured (e.g., a first subset of GUI elements can be configured for display based on user gaze towards a corresponding GUI trigger element for the subset). In some aspects, the GUI management heuristic 520 can generate a GUI control action 530 configured to cause the smart glasses 600 to display respective GUI events or notifications that correspond to respective particular areas and/or respective particular GUI elements within the UI trigger zone 610.

In some aspects, the GUI management heuristic 520 can generate GUI control actions 530, 664, etc., immediately upon the eye tracking framework 510 of FIG. 5 (e.g., and/or the eye tracking framework 660 of FIG. 6) detecting the user's direction of gaze is towards the UI trigger zone 610. In another illustrative example, the GUI management heuristic 520 can generate GUI control actions 530 based on one or more time thresholds (e.g., one or more time threshold values), where the GUI control action 530 is used to configure the smart glasses 600 based on the eye tracking framework 510, 660 detecting the user's direction of gaze towards the UI trigger zone 610 for a length of time that is greater than or equal to the one or more configured time thresholds.

In some cases, the GUI management heuristic 520 can command or configure specific events based on information received from the eye tracking framework 510, 660. For example, the GUI management heuristic 520 can command or configure a first event or event type based on the eye tracking framework 510, 660 detecting a first quantity of blinks by the user, and can command or configure a second event or event type based on the eye tracking framework 510, 660 detecting a second quantity of blinks by the user, etc. In some cases, the GUI management heuristic 520 can generate GUI control actions 530 to command or configure events, GUI modifications or adjustments, etc., based on any action, pattern, series of actions, etc., performed by the user's eyes and detected by the eye tracking framework 510, 660. For instance, any action such as moving the eyes can be used to command or configure one or more corresponding GUI control actions 530. In one illustrative example, a direction of gaze to a particular corner (e.g., of the four corners per transparent pane 690-1, 690-2 of the smart glasses 600) can be used to command or configure a corresponding “hot corner” action, GUI control action, etc. In some aspects, the GUI management heuristic 520 can command or configure GUI control actions 530 based on active inputs by the user, where the active inputs by the user are active changes in the direction of gaze of the user (e.g., rather than a passive inference of where the user is looking).

In some aspects, the GUI management heuristic 520 can be implemented using one or more processors included in the smart glasses 600 and/or various other XR devices implementing the systems and techniques described herein. In some examples, the GUI management heuristic 520 can be implemented locally by one or more processors of the smart glasses 600, and the eye tracking framework 510, 660 can be implemented using a local low-power eye tracking engine of the smart glasses 600. For instance, the local low-power eye tracking engine may run continuously in the background or may run periodically (e.g., 15 times per second, etc.). In some cases, the local low-power eye tracking engine can run on an SoC of the smart glasses 600, while a remaining portion of the SoC is powered down.

FIG. 7 is a diagram illustrating an example GUI rendering process 750 for an XR system 700 (e.g., smart glasses), where the example GUI rendering process 750 corresponds to a determination that an XR device user's direction of gaze is towards a UI defocus zone within a display of the XR system 700. In one illustrative example, the XR system 700 (e.g., also referred to herein as “smart glasses” 700) of FIG. 7 can be the same as or similar to the XR system 400 (e.g., smart glasses 400) of FIG. 4 and/or the XR system 600 (e.g., smart glasses 600) of FIG. 6. For instance, the eye tracking cameras 702-1, 702-2 of FIG. 7 can be the same as or similar to the eye tracking cameras 402-1, 402-2 of FIG. 4 and/or the eye tracking cameras 602-1, 602-2 of FIG. 6; the UI trigger zone 710 of FIG. 7 can be the same as or similar to the UI trigger zone 410 of FIG. 4 and/or the UI trigger zone 610 of FIG. 6; the UI defocus zone 720 of FIG. 7 can be the same as or similar to the UI defocus zone 420 of FIG. 4 and/or the UI defocus zone 620 of FIG. 6; the left transparent pane 790-1 of FIG. 7 can be the same as or similar to the left transparent pane 490-1 of FIG. 4 and/or the left transparent pane 690-1 of FIG. 6; the right transparent pane 790-2 of FIG. 7 can be the same as or similar to the right transparent pane 490-2 of FIG. 4 and/or the right transparent pane 690-2 of FIG. 6; etc.

As noted above, the example GUI rendering process 750 can correspond to an example where a user's gaze is detected towards one (or both) of the respective left and right UI defocus zones 720. In some aspects, the GUI rendering process 750 of FIG. 7 can be implemented by the GUI management system 500 of FIG. 5. For example, the eye tracking framework 760 of FIG. 7 can be the same as or similar to the eye tracking framework 510 of FIG. 5. The eye tracking framework 760 of FIG. 7 can additionally be the same as or similar to the eye tracking framework 660 of FIG. 6. In some cases, block 764 of the GUI rendering process 750 (e.g., rendering low-resolution, dimmed, transparent, etc., representations of one or more GUI elements 770-1, 770-3, 770-5 on or within the left and right transparent panes 790-1, 790-2) can correspond to the GUI control action 530 of FIG. 5. For example, block 764 of GUI rendering process 750 can be implemented by and/or using a GUI management heuristic that is the same as or similar to the GUI management heuristic 520 of FIG. 5.

In one illustrative example, if at block 762 of GUI rendering process 750 the user gaze is detected towards a UI defocus zone 720 (e.g., based on a direction of gaze determined by the eye tracking framework 760 using camera data 752, and provided to a GUI management heuristic), the GUI management heuristic 520 can generate one or more GUI control actions 530 configured to cause the smart glasses 700 to perform dimming, defocusing, and/or disabling of some (or all) of a plurality of GUI elements. For instance, the left transparent pane 790-1 of FIG. 7 can correspond to the rendered GUI content after one or more dimming, defocusing, and/or disabling actions are performed for the respective GUI elements of left transparent pane 690-1 of FIG. 6. For instance, the left transparent pane 790-1 view can be generated based on updating the left transparent pane 690-1 view in response to detecting, at block 762 of the GUI rendering process 750, the user gaze direction towards the UI defocus zone 720 of FIG. 7 and/or IU defocus zone 620 of FIG. 6.

For instance, the left transparent pane 690-1 of FIG. 6 includes the GUI elements 670-1, 670-2, and 670-5 rendered in full resolution. The left transparent pane 790-1 of FIG. 7 can be rendered to disable or remove the GUI element 670-2 (e.g., based on GUI element 670-2 being located within the UI defocus zone 620/720), while dimming, defocusing, or decreasing the opacity of the remaining GUI elements 670-1 and 670-5 (e.g., which are at least partially outside of the UI defocus zone 620/720). For instance, the left transparent pane 790-1 of FIG. 7 can include a dimmed, defocused, or decreased opacity GUI element 770-1 that corresponds to the full resolution GUI element 670-1 of FIG. 6, and a dimmed, defocused, or decreased opacity GUI element 770-5 that corresponds to the full resolution GUI element 670-5 of FIG. 6. Additionally, the right transparent pane 790-2 of FIG. 7 can include dimmed, defocused, or decreased opacity GUI elements 770-3 and 770-4, corresponding to the full resolution GUI elements 670-3 and 670-4 (respectively) of FIG. 6.

In some examples, the smart glasses 700 can perform the dimming, defocusing, and/or disabling of GUI elements based on the eye tracking framework 760 determining that the user's gaze is towards a particular area or sub-area (e.g., within the UI defocus zone 720). In some aspects, the GUI defocus control actions (e.g., dimming, defocusing, decreasing opacity, decreasing resolution, disabling or removing, etc.) can be commanded, configured, implemented, etc., immediately based upon detecting the user's gaze towards a corresponding area or location. In some aspects, the GUI defocus control actions can be commanded, configured, implemented, etc., based on detecting the user's gaze towards the corresponding area or location for a period of time that is greater than or equal to one or more time thresholds (e.g., time threshold values).

For instance, a user direction of gaze within the UI defocus zone 720 that is detected for at least a first threshold length of time can cause the GUI management heuristic 520 of FIG. 5 to generate a GUI control action 530 (e.g., a GUI defocus control action) configured to cause the smart glasses 700 to dim some (or all) of a plurality of GUI elements. A user direction of gaze within the UI defocus zone 720 that is detected for at least a second threshold length of time (e.g., where the second threshold length of time is greater than the first threshold length of time) can cause the GUI management heuristic 520 to generate a GUI control action 530 (e.g., a GUI defocus control action) configured to cause the smart glasses 700 to remove or disable some (or all) of the plurality of GUI elements entirely (e.g., such as removing or disabling the GUI element 670-2 of FIG. 6).

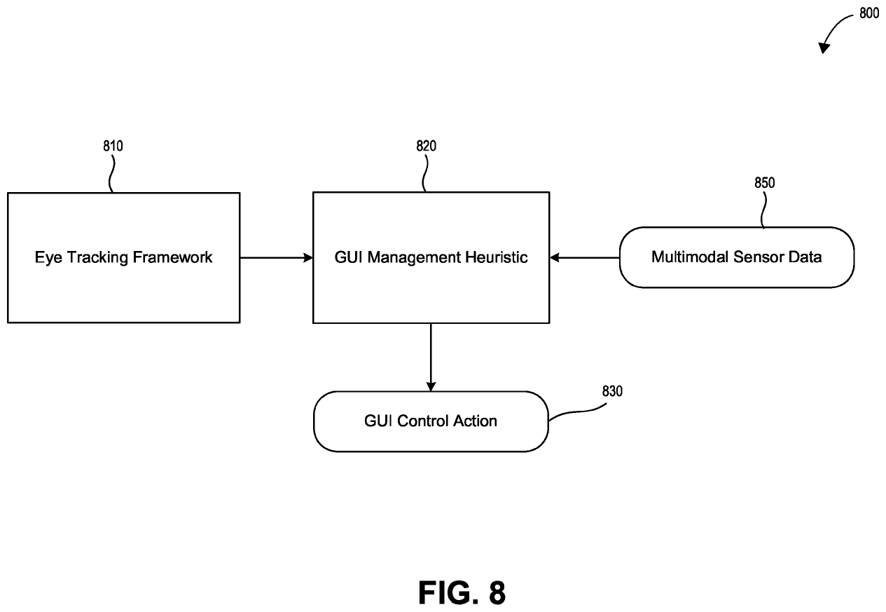

FIG. 8 is a diagram illustrating an example eye tracking GUI management system 800, in accordance with some examples. In some aspects, the eye tracking GUI management system 800 can be the same as or similar to the eye tracking GUI management system 500 of FIG. 5. For instance, the eye tracking framework 800 can be the same as or similar to the eye tracking framework 500 of FIG. 5 (and/or may be the same as or similar to one or more of the eye tracking framework 660 of FIG. 6 and/or the eye tracking framework 760 of FIG. 7). The GUI management heuristic 820 of FIG. 8 may be the same as or similar to the GUI management heuristic 520 of FIG. 5. The GUI control action 830 of FIG. 8 can be the same as or similar to the GUI control action 530 of FIG. 5 (and/or one or more of the UI focus control action 664 of FIG. 6 and/or the UI defocus control action 774 of FIG. 7).

In one illustrative example, the eye tracking GUI management system 800 of FIG. 8 can be the same as the eye tracking GUI management system 500 of FIG. 5 with the addition of one or more multimodal sensor data inputs 850, in accordance with some examples. For instance, in one illustrative example, the smart glasses GUI experience (e.g., the smart glasses GUI management and/or control actions) can be further augmented with multimodal sensor data 850 obtained from one or more multimodal sensors included in, coupled to, or otherwise associated with the smart glasses or other XR device used to implement the systems and techniques described herein. For example, the one or more multimodal sensors can be mounted on a frame of the smart glasses. Example multimodal sensors can include, but are not limited to, one or more of inertial sensors such as accelerometers or gyroscopes, ambient light sensors, ambient temperature sensors, etc. For instance, the one or more multimodal sensors can be included on and/or associated with smart glasses or various other XR devices (e.g., such as the XR device 102 of FIG. 1A; the HMD 120 of FIG. 1B and FIG. 1C; smart glasses implementing the XR system 200 of FIG. 2; the XR device 302 of FIG. 3; the smart glasses 400 of FIG. 4; smart glasses implementing the GUI management system 500 of FIG. 5; the smart glasses 600 of FIG. 6; the smart glasses 700 of FIG. 7; smart glasses implementing the GUI management system 800 of FIG. 8; etc.) In some aspects, multimodal sensor data 850 can be obtained and/or associated with one or more of the image sensor 202, accelerometer 204, gyroscope 206, input device 210, or various other sensors of XR system 200 of FIG. 2.

In some aspects, data from inertial sensors (e.g., inertial sensors included in the one or more multimodal sensors) can be used to identify a usage situation of the wearer of the smart glasses. For example, inertial sensor data can be used to determine that the wearer (e.g., user) of the smart glasses or other XR device is currently performing various activities such as running, walking, cycling, etc. Based on the current activity of the user determined from the inertial sensor data (and/or other multimodal sensor data 850), the smart glasses can be configured to display GUI elements corresponding to the determined user situation and/or otherwise corresponding to the determined current activity of the user. For instance, based on determining that the user's current activity state is walking, running, jogging, cycling, etc., the GUI can be configured to display the user's current speed, average speed, maximum speed, etc.

In another example, data from ambient light sensors and/or ambient temperature sensors may be used to enhance the quality of virtual content displayed on the smart glasses. For instance, brightness and/or transparency levels of the virtual content (e.g., GUI elements, rendered XR media or content, etc.) can be adjusted based on the ambient light sensor data. In another example, one or more respective color tone transformations can be applied for corresponding particular GUI elements based on environmental conditions. The environmental conditions can be based on the ambient light sensor data, the ambient temperature sensor data, etc. In some aspects, the systems and techniques can dynamically generate one or more GUI elements corresponding to the currently detected environmental conditions in which the user is located.

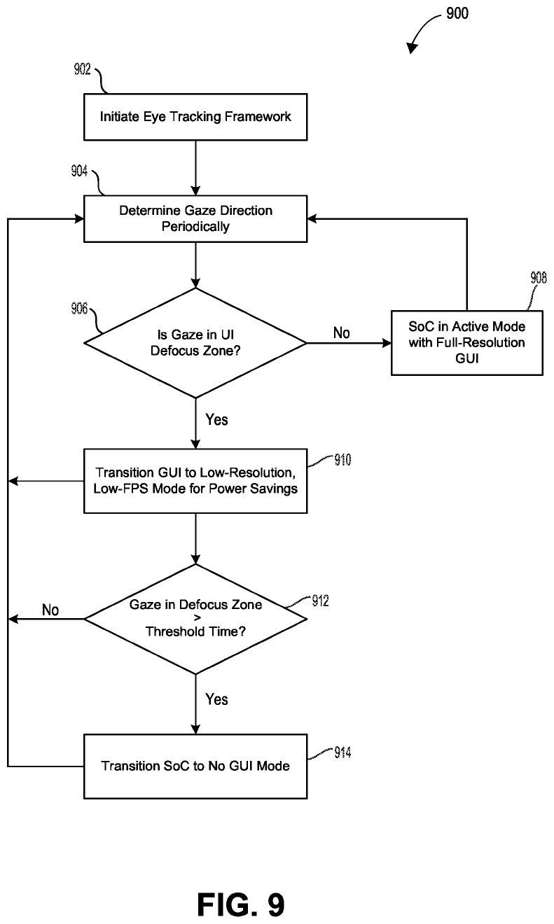

FIG. 9 is a flow diagram illustrating an example process 900 that can be used to implement a control loop for XR GUI management using eye tracking sensors, in accordance with some examples. In some aspects, the control loop 900 can be implemented by and/or associated with smart glasses or various other XR devices described herein (e.g., such as one or more of the XR device 102 of FIG. 1A; the HMD 120 of FIG. 1B and FIG. 1C; smart glasses implementing the XR system 200 of FIG. 2; the XR device 302 of FIG. 3; the smart glasses 400 of FIG. 4; smart glasses implementing the GUI management system 500 of FIG. 5; the smart glasses 600 of FIG. 6; the smart glasses 700 of FIG. 7; smart glasses implementing the GUI management system 800 of FIG. 8; etc.)

At block 902, the process 900 includes initiating an eye tracking framework on the smart glasses or other XR device. For instance, the eye tracking framework can be the same as or similar to one or more of the eye tracking framework 510 of FIG. 5, the eye tracking framework 660 of FIG. 6, the eye tracking framework 760 of FIG. 7, etc.

At block 904, the process 900 includes determining a gaze direction of the user (e.g., wearer) of the smart glasses or other XR device, where the gaze direction is determined periodically (e.g., at a configured interval or periodicity). In one illustrative example, the eye tracking framework initiated at block 902 can be used to determine a gaze direction of the user or wearer of the smart glasses periodically (e.g., 15 times per second, etc.). The gaze direction of the user can be determined based on image data obtained using one or more inward facing cameras of the smart glasses or XR device. For instance, the gaze direction can be determined based on image data obtained from the inward facing cameras 402-1, 402-2 of FIG. 4; the inward facing cameras 602-1, 602-2 of FIG. 6; the inward facing cameras 702-1, 702-2 of FIG. 7; etc. In some aspects, the gaze direction can be determined based on the camera data 652 of FIG. 6 and/or the camera data 752 of FIG. 7.

At block 906, the process 900 includes determining whether the gaze direction of the user is within a UI defocus zone. For example, the determination can be performed by the GUI management heuristic 520 of FIG. 5 and/or the GUI management heuristic 820 of FIG. 8, based on gaze direction information detected by the eye tracking framework initiated at block 902. The UI defocus zone can be the same as or similar to one or more of the UI defocus zone 420 of FIG. 4, the UI defocus zone 620 of FIG. 6, and/or the UI defocus zone 720 of FIG. 7.

The process 900 can proceed to block 908 based a determination (e.g., in block 906) that the user gaze direction is not within the UI defocus zone, a processor or SoC of the smart glasses can be configured in an Active mode, and the GUI management heuristic can generate one or more GUI control actions configured to cause the smart glasses to render and display a full resolution GUI that includes one or more GUI elements. For instance, block 908 can correspond to block 664 of FIG. 6 for implementing a UI focus control action, and block 906 can correspond to block 662 of FIG. 6 for detecting the user gaze in a direction towards the UI trigger zone (e.g., not within the UI defocus zone).

From block 908, the XR GUI management control loop of process 900 can return to block 904 and determine the user gaze direction periodically. The user gaze direction can be determined using a same or configured periodic interval and/or can be determined using a varying periodic interval.

The process 900 can proceed from block 906 to block 910, based on a determination (e.g., in block 906) that the user gaze direction is within the UI defocus zone. For instance, by proceeding from block 906 to block 910, the XR GUI management control loop of process 900 can transition the GUI to a low resolution and/or low frames-per-second (fps) mode for power savings. In some aspects, transitioning the GUI to a low resolution and/or low fps mode at block 910 can additionally include implementing the one or more UI defocus control actions 764 of FIG. 7. For example, block 910 can additionally include dimming, defocusing, reducing the opacity of, removing, disabling, etc., one or more GUI elements that were previously rendered on a display of the smart glasses prior to block 910. For instance, the GUI management heuristic 520 of FIG. 5 can be used to generate one or more GUI control actions 530 configured to cause the smart glasses to transition the GUI to a low resolution and/or low fps mode for power savings, based on the eye tracking framework (e.g., the eye tracking framework initiated at block 902) determining that the user gaze direction is within the UI defocus zone (e.g., at block 906)

In some aspects, the XR GUI management control loop of process 900 can return to block 904 for periodic user gaze direction determination immediately after transitioning the GUI to the low resolution and/or low fps mode at block 910.

In another example, the XR GUI management control loop of process 900 can determine, at block 912, if the user gaze direction remains within the UI defocus zone beyond one or more time thresholds (e.g., for a duration greater than or equal to one or more pre-determined and/or configured time threshold durations).

Based on determining, at block 912, that the user gaze direction did not remain within the UI defocus zone for longer than the configured time threshold(s), the XR GUI management control loop of process 900 can return to block 904 and resume periodically determining the direction of the user's gaze.

Based on determining, at block 912, that the user gaze direction did remain within the UI defocus zone for longer than the configured time threshold(s), the XR GUI management control loop of process 900 can transition a processor or SoC of the smart glasses to a “No GUI” mode at block 914. The No GUI mode implemented at block 914 can correspond to disabling some or all of a plurality of GUI elements included in the GUI that was previously rendered and displayed by the smart glasses (e.g., previously rendered and displayed at one or more of blocks 902-912). After transitioning the processor or SoC to the No GUI mode at 914, the XR GUI management control loop of process 900 can return to block 904 and resume periodically determining the direction of the user's gaze.

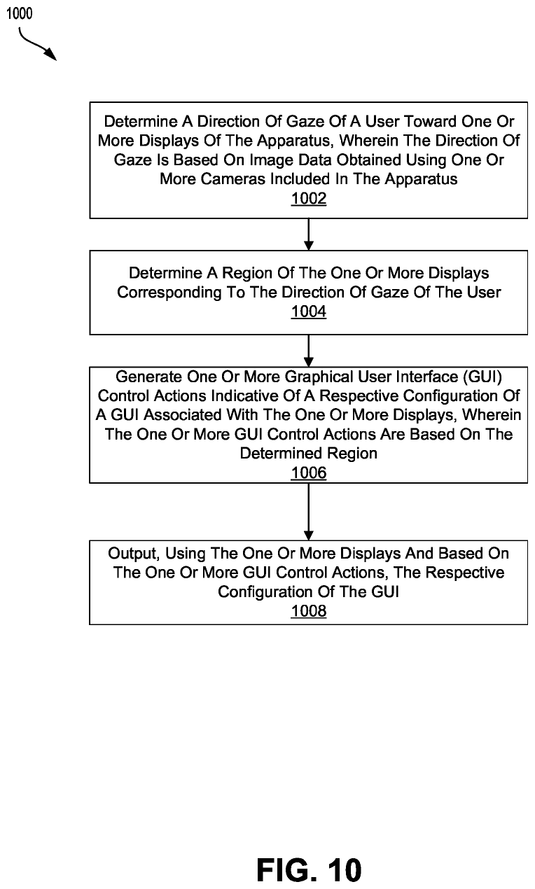

FIG. 10 is a flow diagram illustrating a process 1000 for image processing, in accordance with some examples. The process 1000 may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, or other type of computing device. The operations of the process 1000 may be implemented as software components that are executed and run on one or more processors. In one illustrative example, the process 1000 can be performed by smart glasses or various other XR devices implementing the systems and techniques described herein (e.g., such as one or more of the XR device 102 of FIG. 1A; the HMD 120 of FIG. 1B and FIG. 1C; smart glasses implementing the XR system 200 of FIG. 2; the XR device 302 of FIG. 3; the smart glasses 400 of FIG. 4; smart glasses implementing the GUI management system 500 of FIG. 5; the smart glasses 600 of FIG. 6; the smart glasses 700 of FIG. 7; smart glasses implementing the GUI management system 800 of FIG. 8; smart glasses implementing the XR GUI management control loop of process 900 of FIG. 9; etc.)

At block 1002, the process 1000 includes determining a direction of gaze of a user toward one or more displays of the apparatus, wherein the direction of gaze is based on image data obtained using one or more cameras. For example, the direction of gaze of the user can be determined using an eye tracking framework, such as the eye tracking framework 510 of FIG. 5, the eye tracking framework 660 of FIG. 6, and/or the eye tracking frame 760 of FIG. 6. In some aspects, the eye tracking framework can include and/or be associated with the one or more cameras. In some examples, the one or more cameras include a first inward-facing camera of an extended reality (XR) headset device, and a second inward-facing camera of the XR headset device. For instance, the XR headset device can be the same as or similar to the XR device 102 of FIG. 1A, the HMD 120 of FIGS. 1B and 1C, the XR system 200 of FIG. 2, the XR device 302 of FIG. 3, the XR device (smart glasses) of FIGS. 4, 6, and/or 7, etc. In some cases, the XR headset device is an XR glasses device or a head-mounted display (HMD) device.

In some examples, the direction of gaze can be determined based on image data obtained using one or more inward facing cameras, such as one or more of the inward facing cameras 402-1, 402-2 of FIG. 4; the inward facing cameras 602-1, 602-2 of FIG. 6; the inward facing cameras 702-1, 702-2 of FIG. 7; etc. In some aspects, the gaze direction can be determined based on the camera data 652 of FIG. 6 and/or the camera data 752 of FIG. 7. In some cases, the one or more cameras include a first inward-facing camera of an extended reality (XR) headset device and a second inward-facing camera of the XR headset device. In some examples, the XR headset device is an XR glasses device or a head-mounted display (HMD) device.

In some cases, the apparatus is an extended reality (XR) glasses device, and the one or more displays comprise one or more transparent panes of the XR glasses device. In some examples, the one or more displays of the apparatus can be lenses or transparent panes of a smart glasses or other XR headset device. For instance, the one or more displays can be the same as or similar to the left transparent pane 490-1 and right transparent pane 490-2 of FIG. 4; the left transparent pane 690-1 and the right transparent pane 690-2 of FIG. 6; the left transparent pane 790-1 and the right transparent pane 790-2 of FIG. 7; etc. In some examples, the apparatus can be configured to determine the direction of gaze of the user based on determining a first direction of gaze corresponding to a left eye of the user and based on image data associated with a left eye tracking camera of the XR glasses device. In some examples, the apparatus can be configured to determine a second direction of gaze corresponding to a right eye of the user, based on image data associated with a right eye tracking camera of the XR glasses device. The apparatus intersect the first direction of gaze with a left transparent pane of the XR glasses device to determine a region corresponding to the first direction of gaze. The apparatus can intersect the second direction of gaze with a right transparent pane of the XR glasses device to determine a region corresponding to the second direction of gaze.

In some aspects, block 1002 of the process 1000 can be the same as or similar to block 904 of the process 900 of FIG. 9.

At block 1004, the process 1000 includes determining a region of the one or more displays corresponding to the direction of gaze of the user. For instance, the direction of gaze of the user can be determined to correspond to a UI trigger zone such as the UI trigger zone 410 of FIG. 4, the UI trigger zone 610 of FIG. 6, the UI trigger zone 710 of FIG. 7, etc. The direction of gaze of the user can be determined to correspond to a UI defocus zone such as the UI defocus zone 420 of FIG. 4, the UI defocus zone 620 of FIG. 6, the UI defocus zone 720 of FIG. 7, etc.

In some examples, block 1004 can be the same as or similar to block 904 of process 900 of FIG. 9. In some cases, block 1004 can include block 906 of process 900 of FIG. 9. For example, the determination can be performed by the GUI management heuristic 520 of FIG. 5 and/or the GUI management heuristic 820 of FIG. 8, based on gaze direction information detected by the eye tracking framework at block 1002. In some examples, block 1004 can include and/or can correspond to block 662 of process 650 of FIG. 6 (e.g., detecting the user gaze direction as corresponding to the UI trigger zone region of the one or more displays). In some examples, block 1004 can include and/or can additionally correspond to block 762 of process 750 of FIG. 7 (e.g., detecting the user gaze direction as corresponding to the UI defocus zone region of the one or more displays).

In some examples, an indication of a UI trigger zone can be generated based on the direction of gaze of the user corresponding to (e.g., being within) a first sub-area of an area of the one or more displays. The first sub-area can be the same as the UI trigger zone, and the area of the one or more displays can be an area of the transparent pane of the smart glasses. An indication of a UI defocus zone can be generated based on the direction of gaze of the user corresponding to (e.g., being within) a second sub-area of the area of the one or more displays, wherein the second sub-area is non-overlapping with the first sub-area. The second sub-area can be the same as the UI defocus zone.

In some cases, the indication of the UI trigger zone can be generated based on the direction of gaze of the user corresponding to the first sub-area for at least a first configured time duration. In some cases, the indication of the UI defocus zone can be generated based on the direction of gaze of the user corresponding to the second sub-area for at least a second configured time duration. The first and second configured time durations can be respective time threshold durations or time threshold values. In some examples, the configured time durations can be implemented at block 1004 in a manner the same as or similar to block 912 of process 900 of FIG. 9. In some examples, block 1004 can include block 912 of process 900 of FIG. 9.

At block 1006, the process 1000 includes generating one or more graphical user interface (GUI) control actions indicative of a respective configuration of a GUI associated with the one or more displays, wherein the one or more GUI control actions are based on the determined region. The respective configuration of the GUI can be used for configuring the GUI (e.g., a rendered output or display of the GUI, on a display of a smart glasses or XR device, etc.). For instance, the one or more GUI control actions can be generated using a GUI management heuristic based on gaze direction information determined by the eye tracking framework. In some examples, the GUI management heuristic can be the same as or similar to the GUI management heuristic 520 of FIG. 5 and/or the GUI management heuristic 820 of FIG. 8. The GUI control actions can be the same as or similar to the GUI control action 520 of FIG. 5 and/or the GUI control action 820 of FIG. 8. In some cases, the GUI control action generated at block 1006 can include the UI trigger zone GUI control action 664 of FIG. 6, corresponding to a determination at block 1004 that the user gaze direction corresponds to the UI trigger zone. In some cases, the GUI control action generated at block 1006 can include the UI defocus zone GUI control action 764 of FIG. 7, corresponding to a determination at block 1004 that the user gaze direction corresponds to the UI defocus zone.

In some cases, a first subset of a plurality of GUI control actions can correspond to respective configurations of the GUI based on determining that the user gaze direction is not within the UI defocus zone (e.g., is within the UI trigger zone). For instance, a first subset of the plurality of GUI control actions can correspond to the ‘No’ branch of control loop process 900 of FIG. 9, from block 906 to block 908. Block 908 of process 900 of FIG. 9 can be included in or be associated with the one or more GUI control actions of block 1006 of FIG. 10. A second subset of the plurality of GUI control actions can correspond to respective configurations of the GUI based on determining that the user gaze direction is within the UI defocus zone. For instance, the second subset of the plurality of GUI control cations can correspond to the ‘Yes’ branch of control loop process 900 of FIG. 9, from block 906 to block 910. Block 910 of process 900 of FIG. 9 can be included or be associated with the one or more GUI control actions of block 1006 of FIG. 10. In some aspects, block 914 of control loop process 900 of FIG. 9 can additionally comprise a GUI control action included in the one or more GUI control actions.

In some examples, the apparatus is an extended reality (XR) glasses device, and the one or more displays comprise one or more transparent panes of the XR glasses device. In some cases, the GUI comprises a respective overlay rendered on each transparent pane of the one or more transparent panes. In some examples, the process 1000 can further include determining a first direction of gaze corresponding to a left eye of the user, based on image data associated with a left eye tracking camera of the XR glasses device. A second direction of gaze corresponding to a right eye of the user can be determined based on image data associated with a right eye tracking camera of the XR glasses device. The first direction of gaze can be intersected with a left transparent pane of the XR glasses device to determine a region corresponding to the first direction of gaze. The second direction of gaze can be intersected with a right transparent pane of the XR glasses device to determine a region corresponding to the second direction of gaze.

At block 1008, the process 1000 includes outputting, using the one or more displays and based on the one or more GUI control actions, the respective configuration of the GUI. In some examples, outputting the respective configuration of the GUI comprises rendering (e.g., outputting for display and/or displaying), using the one or more displays, the GUI based on the one or more GUI control actions and with the respective configuration applied to the GUI output.

Rendering the GUI can include displaying, based on the indication of the UI trigger zone, one or more GUI elements of a plurality of GUI elements included in the GUI. In some examples, each GUI element of the plurality of GUI elements can be displayed using a full resolution associated with one or more of the GUI or the one or more displays, or a subset of GUI elements of the plurality of GUI elements can be displayed using the full resolution.

In some examples, the subset of GUI elements can be determined based on a particular area or portion of the one or more displays that corresponds to the direction of gaze of the user. In some examples, based on the indication of the UI trigger zone, one or more GUI events or notifications can be displayed, wherein the one or more GUI events or notifications are based on the direction of gaze of the user corresponding to a particular location within the UI trigger zone.

In some examples, rendering the GUI includes displaying, based on the indication of the UI defocus zone, one or more GUI elements of a plurality of GUI elements included in the GUI, wherein each GUI element of the one or more GUI elements is dimmed or defocused. In some cases, each GUI element of the plurality of GUI elements can be dimmed or defocused based on the indication of the UI defocus zone. In some examples, one or more GUI elements of the plurality of GUI elements can be disabled.

In some cases, rendering the GUI includes dimming or defocusing the one or more GUI elements based on the direction of gaze of the user corresponding to the UI defocus zone for at least a first threshold time duration, and disabling the one or more GUI elements based on the direction of gaze of the user corresponding to the UI defocus zone for at least a second threshold time duration, wherein the second threshold time duration is greater than the first threshold time duration.

In some cases, multimodal sensor data associated with one or more sensors can be obtained and used to determine a current activity or state associated with the user. One or more updated GUI control actions can be generated for configuring the GUI based on the current activity or state associated with the user. In some cases, the one or more sensors include one or more of an inertial sensor, an accelerometer, a gyroscope, an ambient light sensor, or an ambient temperature sensor.

In some cases, one or more particular GUI elements corresponding to the current activity or state associated with the user can be displayed. A brightness or transparency level of virtual content rendered on the one or more displays can be adjusted based on multimodal sensor data associated with one or more of an ambient light sensor or an ambient temperature sensor. One or more color tone transformations can be applied for a corresponding one or more GUI elements based on environmental conditions determined from the multimodal sensor data.

FIG. 11 is a diagram illustrating an example of a computing system for implementing certain aspects of the present technology. In particular, FIG. 11 illustrates an example of computing system 1100, which can be for example any computing device making up internal computing system, a remote computing system, a camera, or any component thereof in which the components of the system are in communication with each other using connection 1105. Connection 1105 can be a physical connection using a bus, or a direct connection into processor 1110, such as in a chipset architecture. Connection 1105 can also be a virtual connection, networked connection, or logical connection.

In some examples, computing system 1100 is a distributed system in which the functions described in this disclosure can be distributed within a datacenter, multiple data centers, a peer network, etc. In some examples, one or more of the described system components represents many such components each performing some or all of the functions for which the component is described. In some cases, the components can be physical or virtual devices.

Example system 1100 includes at least one processing unit (CPU or processor) 1110 and connection 1105 that couples various system components including system memory 1115, such as read-only memory (ROM) 1120 and random access memory (RAM) 1125 to processor 1110. Computing system 1100 can include a cache 1112 of high-speed memory connected directly with, in close proximity to, or integrated as part of processor 1110.

Processor 1110 can include any general purpose processor and a hardware service or software service, such as services 1132, 1134, and 1136 stored in storage device 1130, configured to control processor 1110 as well as a special-purpose processor where software instructions are incorporated into the actual processor design. Processor 1110 may be a completely self-contained computing system, containing multiple cores or processors, a bus, memory controller, cache, etc. A multi-core processor may be symmetric or asymmetric.

To enable user interaction, computing system 1100 includes an input device 1145, which can represent any number of input mechanisms, such as a microphone for speech, a touch-sensitive screen for gesture or graphical input, keyboard, mouse, motion input, speech, camera, accelerometers, gyroscopes, etc. Computing system 1100 can also include output device 1135, which can be one or more of a number of output mechanisms. In some instances, multimodal systems can enable a user to provide multiple types of input/output to communicate with computing system 1100. Computing system 1100 can include communications interface 1140, which can generally govern and manage the user input and system output. The communication interface may perform or facilitate receipt and/or transmission of wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.10 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 1140 may also include one or more Global Navigation Satellite System (GNSS) receivers or transceivers that are used to determine a location of the computing system 1100 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1130 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L#), resistive random-access memory (RRAM/ReRAM), phase change memory (PCM), spin transfer torque RAM (STT-RAM), another memory chip or cartridge, and/or a combination thereof.

The storage device 1130 can include software services, servers, services, etc., that when the code that defines such software is executed by the processor 1110, it causes the system to perform a function. In some examples, a hardware service that performs a particular function can include the software component stored in a computer-readable medium in connection with the necessary hardware components, such as processor 1110, connection 1105, output device 1135, etc., to carry out the function.

As used herein, the term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted using any suitable means including memory sharing, message passing, token passing, network transmission, or the like.

In some examples, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the examples provided herein. However, it will be understood by one of ordinary skill in the art that the examples may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the examples in unnecessary detail. In other instances, well-known circuits, processes, algorithms, structures, and techniques may be shown without unnecessary detail in order to avoid obscuring the examples.

Individual examples may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific examples thereof, but those skilled in the art will recognize that the application is not limited thereto. Thus, while illustrative examples of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, examples can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate examples, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the examples disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:

Aspect 1. An apparatus for imaging, the apparatus comprising: at least one memory; and at least one processor coupled to the at least one memory and configured to: determine a direction of gaze of a user toward one or more displays of the apparatus, wherein the direction of gaze is based on image data obtained using one or more cameras included in the apparatus; determine a region of the one or more displays corresponding to the direction of gaze of the user; generate one or more graphical user interface (GUI) control actions indicative of a respective configuration of a GUI associated with the one or more displays, wherein the one or more GUI control actions are based on the determined region; and output, using the one or more displays and based on the one or more GUI control actions, the respective configuration of the GUI.

Aspect 2. The apparatus of Aspect 1, wherein, to determine the region of the one or more displays corresponding to the direction of gaze of the user, the at least one processor is configured to: generate an indication of a UI trigger zone based on the direction of gaze of the user corresponding to a first sub-area of a larger area of the one or more displays; or generate an indication of a UI defocus zone based on the direction of gaze of the user corresponding to a second sub-area of the larger area of the one or more displays, wherein the second sub-area is non-overlapping with the first sub-area.

Aspect 3. The apparatus of Aspect 2, wherein the at least one processor is further configured to: generate the indication of the UI trigger zone based on the direction of gaze of the user corresponding to the first sub-area for at least a first configured time duration; or generate the indication of the UI defocus zone based on the direction of gaze of the user corresponding to the second sub-area for at least a second configured time duration.

Aspect 4. The apparatus of any of Aspects 2 to 3, wherein, to output the respective configuration of the GUI, the at least one processor is configured to: display, based on the indication of the UI trigger zone, one or more GUI elements of a plurality of GUI elements included in the GUI.

Aspect 5. The apparatus of Aspect 4, wherein the one or more GUI elements comprise a subset of the plurality of GUI elements corresponding to a particular sub-area of a larger area of the one or more displays, and wherein the direction of gaze of the user is detected within the particular sub-area.

Aspect 6. The apparatus of any of Aspects 4 to 5, wherein the at least one processor is configured to: display, based on the indication of the UI trigger zone, one or more GUI events or notifications; wherein the one or more GUI events or notifications are output based on the direction of gaze of the user corresponding to a particular location within the first sub-area corresponding to the UI trigger zone.

Aspect 7. The apparatus of any of Aspects 2 to 6, wherein, to output the respective configuration of the GUI, the at least one processor is configured to: display, based on the indication of the UI defocus zone, one or more GUI elements of a plurality of GUI elements included in the GUI, wherein each GUI element of the one or more GUI elements is dimmed or defocused.

Aspect 8. The apparatus of Aspect 7, wherein, to output the respective configuration of the GUI, the at least one processor is further configured to disable one or more GUI elements of the plurality of GUI elements.

Aspect 9. The apparatus of any of Aspects 7 to 8, wherein, to output the respective configuration of the GUI, the at least one processor is configured to: dim or defocus the one or more GUI elements based on the direction of gaze of the user corresponding to the UI defocus zone for at least a first configured time duration; and disable the one or more GUI elements based on the direction of gaze of the user corresponding to the UI defocus zone for at least a second configured time duration, wherein the second configured time duration is greater than the first configured time duration.

Aspect 10. The apparatus of any of Aspects 1 to 9, wherein, to determine the direction of gaze of the user, the at least one processor is configured to determine the direction of gaze of the user using an eye tracking framework, wherein the eye tracking framework is associated with the one or more cameras.

Aspect 11. The apparatus of Aspect 10, wherein the one or more cameras include a first inward-facing camera of an extended reality (XR) headset device, and a second inward-facing camera of the XR headset device.

Aspect 12. The apparatus of Aspect 11, wherein the XR headset device is an XR glasses device or a head-mounted display (HMD) device.

Aspect 13. The apparatus of any of Aspects 1 to 12, wherein, to generate the one or more GUI control actions, the at least one processor is configured to: determine gaze direction information using an eye tracking framework associated with the one or more cameras; and generate the one or more GUI control actions using a GUI management heuristic.

Aspect 14. The apparatus of any of Aspects 1 to 13, wherein: the apparatus is an extended reality (XR) glasses device; the one or more displays comprise one or more transparent panes of the XR glasses device; and the GUI comprises a respective overlay rendered on each transparent pane of the one or more transparent panes.

Aspect 15. The apparatus of Aspect 14, wherein the at least one processor is configured to: determine a first direction of gaze corresponding to a left eye of the user, based on image data associated with a left eye tracking camera of the XR glasses device; determine a second direction of gaze corresponding to a right eye of the user, based on image data associated with a right eye tracking camera of the XR glasses device; intersect the first direction of gaze with a left transparent pane of the XR glasses device to determine a region corresponding to the first direction of gaze; and intersect the second direction of gaze with a right transparent pane of the XR glasses device to determine a region corresponding to the second direction of gaze.

Aspect 16. The apparatus of any of Aspects 1 to 15, wherein the at least one processor is further configured to: obtain multimodal sensor data associated with one or more sensors included in the apparatus; determine, based on the multimodal sensor data, one or more of a current activity or a current state associated with the user; and generate one or more updated GUI control actions based on one or more of the current activity or the current state, wherein each respective updated GUI control action of the one or more updated GUI control actions is indicative of a corresponding updated configuration for the GUI.

Aspect 17. The apparatus of Aspect 16, wherein the at least one processor is configured to: display one or more GUI elements corresponding to the current activity or current state associated with the user; and adjust a brightness or transparency level of virtual content rendered on the one or more displays based on multimodal sensor data associated with one or more of an ambient light sensor or an ambient temperature sensor; or apply one or more color tone transformations for a corresponding one or more GUI elements based on environmental conditions determined from the multimodal sensor data.

Aspect 18. A method for imaging, the method comprising: determining a direction of gaze of a user toward one or more displays, wherein the direction of gaze is based on image data obtained using one or more cameras; determining a region of the one or more displays corresponding to the direction of gaze of the user; generating one or more graphical user interface (GUI) control actions indicative of a respective configuration of a GUI associated with the one or more displays, wherein the one or more GUI control actions are based on the determined region; and outputting, using the one or more displays and based on the one or more GUI control actions, the respective configuration of the GUI.

Aspect 19. The method of Aspect 18, wherein determining the region of the one or more displays corresponding to the direction of gaze of the user comprises: generating an indication of a UI trigger zone based on the direction of gaze of the user corresponding to a first sub-area of a larger area of the one or more displays; or generating an indication of a UI defocus zone based on the direction of gaze of the user corresponding to a second sub-area of the larger area of the one or more displays, wherein the second sub-area is non-overlapping with the first sub-area.

Aspect 20. The method of Aspect 19, further comprising: generating the indication of the UI trigger zone based on the direction of gaze of the user corresponding to the first sub-area for at least a first configured time duration; or generating the indication of the UI defocus zone based on the direction of gaze of the user corresponding to the second sub-area for at least a second configured time duration.

Aspect 21. The method of any of Aspects 19 to 20, wherein outputting the respective configuration of the GUI comprises: displaying, based on the indication of the UI trigger zone, one or more GUI elements of a plurality of GUI elements included in the GUI.

Aspect 22. The method of Aspect 21, wherein the one or more GUI elements comprise a subset of the plurality of GUI elements corresponding to a particular sub-area of a larger area of the one or more displays, and wherein the direction of gaze of the user is detected within the particular sub-area.

Aspect 23. The method of any of Aspects 21 to 22, further comprising: displaying, based on the indication of the UI trigger zone, one or more GUI events or notifications; wherein the one or more GUI events or notifications are output based on the direction of gaze of the user corresponding to a particular location within the first sub-area corresponding to the UI trigger zone.

Aspect 24. The method of any of Aspects 19 to 23, wherein outputting the respective configuration of the GUI comprises: displaying, based on the indication of the UI defocus zone, one or more GUI elements of a plurality of GUI elements included in the GUI, wherein each GUI element of the one or more GUI elements is dimmed or defocused or disabled.

Aspect 25. The method of Aspect 24, wherein outputting the respective configuration of the GUI comprises: dimming or defocusing the one or more GUI elements based on the direction of gaze of the user corresponding to the UI defocus zone for at least a first configured time duration; and disabling the one or more GUI elements based on the direction of gaze of the user corresponding to the UI defocus zone for at least a second configured time duration, wherein the second configured time duration is greater than the first configured time duration.

Aspect 26. The method of any of Aspects 18 to 25, further comprising determining the direction of gaze of the user using an eye tracking framework associated with the one or more cameras, wherein the one or more cameras include a first inward-facing camera of an extended reality (XR) headset device and a second inward-facing camera of the XR headset device.

Aspect 27. The method of Aspect 26, wherein the XR headset device is an XR glasses device or a head-mounted display (HMD) device.

Aspect 28. The method of any of Aspects 18 to 27, further comprising: obtaining multimodal sensor data associated with one or more sensors; determining, based on the multimodal sensor data, one or more of a current activity or a current state associated with the user; and generating one or more updated GUI control actions based on one or more of the current activity or the current state, wherein each respective updated GUI control action of the one or more updated GUI control actions is indicative of a corresponding updated configuration for the GUI.

Aspect 29. The method of Aspect 28, wherein the one or more sensors include one or more of an inertial sensor, an accelerometer, a gyroscope, an ambient light sensor, or an ambient temperature sensor.

Aspect 30. The method of any of Aspects 28 to 29, further comprising: displaying one or more GUI elements corresponding to the current activity or current state associated with the user; and adjusting a brightness or transparency level of virtual content rendered on the one or more displays based on multimodal sensor data associated with one or more of an ambient light sensor or an ambient temperature sensor; or applying one or more color tone transformations for a corresponding one or more GUI elements based on environmental conditions determined from the multimodal sensor data.

Aspect 31. A non-transitory computer-readable medium storing instructions that, when executed by one or more processors, cause the one or more processors to perform operations according to any of Aspects 1 to 17.

Aspect 32. A non-transitory computer-readable medium storing instructions that, when executed by one or more processors, cause the one or more processors to perform operations according to any of Aspects 18 to 30.

Aspect 33. An apparatus comprising one or more means for performing operations according to any of Aspects 1 to 17.

Aspect 34. An apparatus comprising one or more means for performing operations according to any of Aspects 18 to 30.

1. An apparatus for imaging, the apparatus comprising:
at least one memory; and
at least one processor coupled to the at least one memory and configured to:
determine a direction of gaze of a user toward one or more displays of the apparatus, wherein the direction of gaze is based on image data obtained using one or more cameras included in the apparatus;
determine a region of the one or more displays corresponding to the direction of gaze of the user;
generate one or more graphical user interface (GUI) control actions indicative of a respective configuration of a GUI associated with the one or more displays, wherein the one or more GUI control actions are based on the determined region; and
output, using the one or more displays and based on the one or more GUI control actions, the respective configuration of the GUI.

2. The apparatus of claim 1, wherein, to determine the region of the one or more displays corresponding to the direction of gaze of the user, the at least one processor is configured to:
generate an indication of a UI trigger zone based on the direction of gaze of the user corresponding to a first sub-area of a larger area of the one or more displays; or
generate an indication of a UI defocus zone based on the direction of gaze of the user corresponding to a second sub-area of the larger area of the one or more displays, wherein the second sub-area is non-overlapping with the first sub-area.

3. The apparatus of claim 2, wherein the at least one processor is further configured to:
generate the indication of the UI trigger zone based on the direction of gaze of the user corresponding to the first sub-area for at least a first configured time duration; or
generate the indication of the UI defocus zone based on the direction of gaze of the user corresponding to the second sub-area for at least a second configured time duration.

4. The apparatus of claim 2, wherein, to output the respective configuration of the GUI, the at least one processor is configured to:
display, based on the indication of the UI trigger zone, one or more GUI elements of a plurality of GUI elements included in the GUI.

5. The apparatus of claim 4, wherein the one or more GUI elements comprise a subset of the plurality of GUI elements corresponding to a particular sub-area of a larger area of the one or more displays, and wherein the direction of gaze of the user is detected within the particular sub-area.

6. The apparatus of claim 4, wherein the at least one processor is configured to:
display, based on the indication of the UI trigger zone, one or more GUI events or notifications;
wherein the one or more GUI events or notifications are output based on the direction of gaze of the user corresponding to a particular location within the first sub-area corresponding to the UI trigger zone.

7. The apparatus of claim 2, wherein, to output the respective configuration of the GUI, the at least one processor is configured to:
display, based on the indication of the UI defocus zone, one or more GUI elements of a plurality of GUI elements included in the GUI, wherein each GUI element of the one or more GUI elements is dimmed or defocused.

8. The apparatus of claim 7, wherein, to output the respective configuration of the GUI. the at least one processor is further configured to disable one or more GUI elements of the plurality of GUI elements.

9. The apparatus of claim 7, wherein, to output the respective configuration of the GUI. the at least one processor is configured to:
dim or defocus the one or more GUI elements based on the direction of gaze of the user corresponding to the UI defocus zone for at least a first configured time duration; and
disable the one or more GUI elements based on the direction of gaze of the user corresponding to the UI defocus zone for at least a second configured time duration, wherein the second configured time duration is greater than the first configured time duration.

10. (canceled)

11. (canceled)

12. (canceled)

13. The apparatus of claim 1, wherein, to generate the one or more GUI control actions, the at least one processor is configured to:
determine gaze direction information using an eye tracking framework associated with the one or more cameras; and
generate the one or more GUI control actions using a GUI management heuristic.

14. The apparatus of claim 1, wherein:
the apparatus is an extended reality (XR) glasses device;
the one or more displays comprise one or more transparent panes of the XR glasses device; and
the GUI comprises a respective overlay rendered on each transparent pane of the one or more transparent panes.

15. The apparatus of claim 14, wherein the at least one processor is configured to:
determine a first direction of gaze corresponding to a left eye of the user, based on image data associated with a left eye tracking camera of the XR glasses device;
determine a second direction of gaze corresponding to a right eye of the user, based on image data associated with a right eye tracking camera of the XR glasses device;
intersect the first direction of gaze with a left transparent pane of the XR glasses device to determine a region corresponding to the first direction of gaze; and
intersect the second direction of gaze with a right transparent pane of the XR glasses device to determine a region corresponding to the second direction of gaze.

16. The apparatus of claim 1, wherein the at least one processor is further configured to:
obtain multimodal sensor data associated with one or more sensors included in the apparatus;
determine, based on the multimodal sensor data, one or more of a current activity or a current state associated with the user; and
generate one or more updated GUI control actions based on one or more of the current activity or the current state, wherein each respective updated GUI control action of the one or more updated GUI control actions is indicative of a corresponding updated configuration for the GUI.

17. The apparatus of claim 16, wherein the at least one processor is configured to:
display one or more GUI elements corresponding to the current activity or current state associated with the user; and
adjust a brightness or transparency level of virtual content rendered on the one or more displays based on multimodal sensor data associated with one or more of an ambient light sensor or an ambient temperature sensor: or
apply one or more color tone transformations for a corresponding one or more GUI elements based on environmental conditions determined from the multimodal sensor data.

18. A method for imaging, the method comprising:
determining a direction of gaze of a user toward one or more displays, wherein the direction of gaze is based on image data obtained using one or more cameras;
determining a region of the one or more displays corresponding to the direction of gaze of the user;
generating one or more graphical user interface (GUI) control actions indicative of a respective configuration of a GUI associated with the one or more displays, wherein the one or more GUI control actions are based on the determined region; and
outputting, using the one or more displays and based on the one or more GUI control actions, the respective configuration of the GUI.

19. The method of claim 18, wherein determining the region of the one or more displays corresponding to the direction of gaze of the user comprises:
generating an indication of a UI trigger zone based on the direction of gaze of the user corresponding to a first sub-area of a larger area of the one or more displays; or
generating an indication of a UI defocus zone based on the direction of gaze of the user corresponding to a second sub-area of the larger area of the one or more displays, wherein the second sub-area is non-overlapping with the first sub-area.

20. The method of claim 19, further comprising:
generating the indication of the UI trigger zone based on the direction of gaze of the user corresponding to the first sub-area for at least a first configured time duration; or
generating the indication of the UI defocus zone based on the direction of gaze of the user corresponding to the second sub-area for at least a second configured time duration.

21. The method of claim 19 wherein outputting the respective configuration of the GUI comprises:
displaying, based on the indication of the UI trigger zone, one or more GUI elements of a plurality of GUI elements included in the GUI.

22. (canceled)

23. (canceled)

24. (canceled)

25. (canceled)

26. (canceled)

27. (canceled)

28. The method of claim 18, further comprising:
obtaining multimodal sensor data associated with one or more sensors;
determining, based on the multimodal sensor data, one or more of a current activity or a current state associated with the user; and
generating one or more updated GUI control actions based on one or more of the current activity or the current state, wherein each respective updated GUI control action of the one or more updated GUI control actions is indicative of a corresponding updated configuration for the GUI.

29. (canceled)

30. The method of claim 28. further comprising:
displaying one or more GUI elements corresponding to the current activity or current state associated with the user; and
adjusting a brightness or transparency level of virtual content rendered on the one or more displays based on multimodal sensor data associated with one or more of an ambient light sensor or an ambient temperature sensor; or
applying one or more color tone transformations for a corresponding one or more GUI elements based on environmental conditions determined from the multimodal sensor data.
